(19) United States
(12) Patent Application Publication
(10) Pub. No.: US 2026/0312857 A1
(43) Pub. Date: Oct. 8, 2026

(54) BAND GAP MITIGATION DURING COMPONENT CARRIER SENSING

(71) Applicant: Intel Corporation, Santa Clara, CA (US)

(72) Inventors: Thushara Hewavithana, Tempe, AZ (US); Fatemeh Hamidi-Sepehr, San Jose, CA (US)

(21) Appl. No.: 19/479,177

(22) PCT Filed: Dec. 20, 2023
(86) PCT No.: PCT/US2023/085078

§ 371 Date: Oct. 27, 2025

Related U.S. Application Data
(60) Provisional application No. 63/528,592, filed on Jul. 24, 2023.

(51) Int. Cl. H04L 27/26

(52) U.S. Cl. CPC H04L 27/2672; H04L 27/2659; H04L 27/266

(57) ABSTRACT

A method for phase correction includes determining a channel impulse response of a first component carrier associated with a first bandwidth, and determining a location of a first impulse response peak within the first bandwidth. A location of a second impulse response peak within a second bandwidth associated with the first component carrier or with a second component carrier is determined based on the location of the first impulse response peak. The second bandwidth is disjoint with the first bandwidth. A phase correction of one of a channel frequency response of the first bandwidth and a channel frequency response of the second bandwidth is performed based on the first impulse response peak and the second impulse response peak.

### PRIORITY CLAIM

This application claims the benefit of priority to U.S. Provisional Patent Application No. 63/528,592, filed Jul. 24, 2023, and entitled “TECHNIQUES FOR MITIGATING EFFECTS OF BAND GAPS WHEN SENSING OVER AGGREGATED CARRIERS,” which application is incorporated herein by reference in its entirety.

### BACKGROUND

Wireless systems can operate using multiple radio access technologies in multiple frequency bands, and there may be minimal frequency separation between the frequency bands. Furthermore, systems are expected to expand usage into these or other frequency bands using various other communications technologies, such as carrier aggregation. It is desirable to support wireless communications, including communications using carrier aggregation. Therefore, there is a general need for techniques related to mitigating the effects of band gaps when sensing over aggregated carriers.

### BRIEF DESCRIPTION OF THE DRAWINGS

In the drawings, which are not necessarily drawn to scale, like numerals may describe similar components in different views. Like numerals having different letter suffixes may represent different instances of similar components. Some aspects are illustrated by way of example, and not limitation, in the figures of the accompanying drawings in which:

FIG. 1A illustrates an exemplary user device according to some aspects.

FIG. 1B illustrates a mm Wave system, which can be used in connection with the device of FIG. 1A according to some aspects.

FIG. 2 illustrates an exemplary base station radio head according to some aspects.

FIG. 3A illustrates exemplary wireless communication circuitry according to some aspects.

FIG. 3B illustrates aspects of exemplary transmit circuitry illustrated in FIG. 3A according to some aspects.

FIG. 3C illustrates aspects of exemplary transmit circuitry illustrated in FIG. 3A according to some aspects.

FIG. 3D illustrates aspects of exemplary radio frequency circuitry illustrated in FIG. 3A according to some aspects.

FIG. 3E illustrates aspects of exemplary receive circuitry in FIG. 3A according to some aspects.

FIG. 4 illustrates exemplary useable RF circuitry in FIG. 3A according to some aspects.

FIG. 5A illustrates an aspect of an exemplary radio front-end module (RFEM) according to some aspects.

FIG. 5B illustrates an alternate aspect of an exemplary radio front-end module, according to some aspects.

FIG. 6 illustrates an exemplary multi-protocol baseband processor that is usable in FIG. 1A, FIG. 1B or FIG. 2, according to some aspects.

FIG. 7 illustrates an exemplary mixed-signal baseband subsystem, according to some aspects.

FIG. 8A illustrates an exemplary digital baseband subsystem, according to some aspects.

FIG. 8B illustrates an alternate aspect of an exemplary baseband processing subsystem, according to some aspects.

FIG. 9 illustrates an exemplary digital signal processor subsystem, according to some aspects.

FIG. 10 illustrates diagram 1000 of a single transmitter radio frequency (RF) and baseband chain (top), as well as a single receiver RF and baseband chain (bottom), configured to sense over multiple CCs, according to some aspects.

FIG. 11 illustrates a flow diagram of a method for phase mismatch and group delay compensation in a non-coherent CCs case, according to some aspects.

FIG. 12 illustrates a graph of S_{K/N}(Δₘ) versus Δₘ, according to some aspects.

FIG. 13 illustrates a flow diagram of a method for spectral gap reconstruction between coherent disjoint bandwidths (BWs), according to some aspects.

FIG. 14 illustrates a graph of a range profile without calibration and spectral gap reconstruction, according to some aspects.

FIG. 15 illustrates a graph of a range profile with calibration and before spectral gap reconstruction, according to some aspects.

FIG. 16 illustrates a graph of a range profile with calibration and spectral gap reconstruction, according to some aspects.

FIG. 17 illustrates a graph of sensing misdetection probability versus the relative amplitude of the two targets, according to some aspects.

FIG. 18 illustrates a graph of sensing misdetection probability versus distance difference between the two targets, according to some aspects.

FIG. 19 is a flow diagram illustrating a method for phase correction in a wireless system, in accordance with some aspects.

FIG. 20 illustrates a block diagram of a communication device such as an evolved Node-B (eNB), a new generation Node-B (gNB), an access point (AP), a wireless station (STA), a mobile station (MS), or a user equipment (UE), in accordance with some aspects.

### DETAILED DESCRIPTION

The following description and the drawings sufficiently illustrate specific aspects to enable those skilled in the art to practice them. Other aspects may incorporate structural, logical, electrical, process, and other changes. Portions and features of some aspects may be included in or substituted for those of other aspects. Aspects outlined in the claims encompass all available equivalents of those claims.

Wireless systems can operate using different radio access technologies (such as Wi-Fi and cellular technologies) in multiple frequency bands, including the 5 gigahertz (GHz) band (5150-5895 megahertz (MHz)) and the 6 GHz band (5945-7125 MHz). These and other frequency bands have a minimal frequency separation between them; in the example of the 5 GHz band and the 6 GHz band, there are only 50 MHz of frequency separation. Bluetooth is also expected to operate in one of these bands in the near future.

Next-generation wireless communication systems, such as beyond 5G (B5G) and 6G, are envisioned to support several emerging applications, such as smart cities and industry, road safety, connected vehicles, and remote health care. Sensing is expected to be an integral part of future wireless networks, playing a significant role in location/environment-aware scenarios.

Radar sensing is a key envisioned feature in the next generations of wireless systems, which allows the use of communication infrastructure and air interface components to perceive the environment. Enabling efficient use of the radio spectrum to meet various communication and sensing use case requirements is one of the main goals of such systems. Due to the dependency of sensing detection performance on the radio signal's frequency bandwidth (BW) and the fact that a contiguous wide bandwidth may not always be available, it is essential to equip future wireless systems with techniques to enable high-performance sensing over disjoint aggregated bandwidths. The disclosed techniques include sensing receiver techniques to enable both incoherent and coherent sensing processing across disjoint BWs and improve sensing range detection performance. Such disjoint BWs may occur due to multiple component carriers (CCs) or gaps within an individual CC.

Carrier Aggregation (CA) is a technique currently used in existing wireless communication systems to increase the bandwidth and, thereby, the bitrate by assigning frequency resources over multiple frequency blocks (called Component Carriers-CCs) for signal transmission and reception. CA plays a significant role in LTE Advanced and 5G NR systems in extending coverage and increasing the network capacity using the existing spectrum. LTE R-10 and LTE R-13 (i.e., LTE Advanced-PRO) support CA with up to 5 and 32 CCs, respectively, each CC expanding over 1.4, 3, 5, 10, or 20 MHz bandwidth. 5G NR supports CA with up to 16 CCs, each CC with a bandwidth of up to 100 MHz and 400 MHz in Frequency Ranges 1 and 2 (FR 1 and FR2), respectively.

In CA for communications, physical channels and signals are usually not expected to be processed coherently. Instead, different and independent data are sent and received over different CCs. This forms a distinction between communication versus sensing and localization processing needs. For sensing and localization, which rely on timing-based measurements, significant gains are revealed when the aggregated bandwidths are coherently processed. In that sense, bandwidth aggregation for high-accuracy localization and sensing measurement offers a new scenario compared to the current support of CA in communication networks and creates new behaviors and challenges to be investigated. One of the critical challenges in performing sensing processing over disjoint aggregated bandwidths is the increased sidelobes power in the range profile, resulting in reduced detection probability and increased false-alarm probability. In radar detection performance, peak to sidelobe power is an important measure, especially in multiple target environments, as the sidelobes of strong targets can drown the main lobes of weak targets' reflections. Hence, proper measures can be used to reduce the range of sidelobes.

The disclosed techniques introduce sensing receiver signal processing techniques to enable OFDM-based sensing processing across both incoherent and coherent disjoint frequency BWs and improve sensing range detection performance. The disclosed techniques include the following functionalities

(a) Phase mismatch calibration. First, a signal processing method is disclosed for the estimation and compensation of group delay differences due to RF mismatches across disjoint bandwidths, bringing the bandwidths into a coherent framework. More specifically, an OFDM-based receiver signal processing method is disclosed for compensation of group delay differences due to RF mismatches across disjoint bandwidths, bringing the bandwidths into a coherent framework. This method is referred to as a phase mismatch calibration technique.

(b) Dynamic range improvement. Assuming that the aggregated disjoint bandwidths are phase coherent, the disclosed techniques also include a method to suppress the range sidelobes associated with the spectral gaps, which reconstructs and fills in the spectral gaps via an estimation based on the dominant peaks in the range profile. This gap estimation and reconstruction method uses the range data with reasonable computational complexity for OFDM-based sensing detection over a disjoint spectrum.

In summary, the disclosed techniques use the aggregated spectrum for sensing, which is one of the critical enablers for using sensing in cellular systems (to provide the significant bandwidths sensing need), without requiring wideband RF components and without impacting regulations on the spectrum usage, Tx power, etc.

The disclosed techniques are associated with the following advantages:

(a) Even though an essential application of the disclosed techniques is in the context of sensing integration in future wireless systems, the disclosed algorithms are equally applicable to any radar sensing system that deals with discontinuities in the spectrum.

(b) The disclosed techniques are applicable for implementing sensing using even existing 5G signaling, such as positioning reference signals (PRS).

(c) The disclosed techniques for calibration of CCs relative groups delays using signal processing techniques without the need for additional hardware capabilities can be advantageous when deploying sensing over brownfield deployments.

(d) In some aspects, there are gaps in a cellular spectrum—be it between CCs or within CCs for various purposes. For example, between CCs, the gap is required to meet RF requirements for BS and UEs. The band gap reconstruction method in the disclosed techniques can be used to mitigate the impact on sensing performance in these cases.

(e) There are also various scenarios where the spectrum is shared between cellular and other systems requiring cellular spectrum to vacate certain frequency bands. For example, ESC-environmental sensing capability in the 3.5 GHz band may determine some spectrum being used by US Navy communications, which will require the cellular system to leave a gap in this spectrum so that cellular does not interfere with critical communication. With the disclosed techniques, sensing can still be done with minimal impact due to the gap in the sensing spectrum.

However, in CA, for communications, physical channels, and signals are usually not expected to be processed coherently. Instead, different and independent data are sent and received over different CCs. This forms a distinction between communication localization and sensing processing needs. For localization and sensing, which rely on timing-based measurements, significant gains are revealed when the aggregated bandwidths are coherently processed. In this regard, bandwidth aggregation for high-accuracy localization and sensing measurement offers a new scenario compared to the current support of CA in communication networks. It creates new behaviors and challenges to be investigated. One of the critical challenges in performing sensing processing over disjoint aggregated bandwidths is the increased sidelobes power in the range profile, which can result in the decline of detection probability and high false alarm probability. Generally, in the radar detection process, peak-to-sidelobe power is an important measure, especially in the multiple target environment, since the sidelobe of the strong targets can cover the main lobes of weak targets' reflections. Proper measures should then be taken to reduce the range of sidelobes.

In the radar signal processing literature, several concepts related to disjoint frequency resources with their respective challenges and proposed solutions are widely studied. Despite certain similarities to the settings of the problem at hand, each stems from a fundamentally different paradigm. For example, frequency agile radar is a well-studied technology in which the radar operating in jammed environments can quickly shift its operating frequency to account for atmospheric effects, jamming, and mutual interference with friendly sources. Frequency agility makes coherent processing a challenging task for the radar, and a category of research studies focuses on the solutions to this challenge. Cognitive radar is another related concept that allows operation on the principle of dynamic spectrum access. Spectrum nulling techniques to avoid interference with specific frequency resources also form another category of research. Noncontiguous waveforms such as non-contiguous orthogonal frequency division multiplexing (NC-OFDM) transmit signals on disjoint, narrower bandwidth channels. They are then studied as a candidate for cognitive radio operation or spectrum nulling.

On the other hand, discontinuous waveforms have the downside of sidelobe existence that generates high out-of-band radiations. Accordingly, a large body of work in sparse or disjoint frequency transmit waveform design has been reported in the literature. Many of such schemes strive to reduce sidelobes' power by solving heuristic or [convex] optimization problems to calculate proper transmit waveform parametrization, such as subcarrier weighting, under different constraints. However, these are different from the problem of focus in the current disclosure, which deals with the receiver processing techniques for the improved radar detection performance for transmission over disjoint frequency resources.

The disclosed techniques include receiver signal processing methods to enable sensing over disjoint bandwidths. Mainly, two issues are addressed by the disclosed techniques: First, a signal processing method for compensation of possible phase incoherency between the transmitted signals over the disjoint bandwidths is disclosed. Unlike core detection processing, this process is only needed at the beginning of the operation and probably at certain later infrequent instances to calibrate the receiver. This method enables coherent combining of the received signal over the disjoint bandwidth even when due to RF mismatches, timing offset, and phase errors exist between the transmitted signals over the disjoint bandwidths.

Second, a method to suppress the range sidelobes associated with sensing over disjoint coherent bandwidths is disclosed while keeping the computation complexity at a reasonable level. To lower the range sidelobes for discontinuous spectrum waveform, the disclosed techniques may also use radar receiver spectral estimation, which reduces the sharpness of the spectral discontinuities and plugs the spectral gaps. In a similar vein, the receiver signal processing method proposed in the current disclosure approximately reconstructs and fills in the spectral gaps through an estimation based on the detected peaks in the range profile. While some processing may consider an iterative method for the spectrum estimation (which relies on the range and Doppler processing) and focuses on the over-the-horizon HF radars for a repeated linear FM test case suited to synthetic-aperture radar images, the disclosed techniques develop a gap estimation and reconstruction method with reasonable computational complexity, for OFDM-based sensing detection over the disjoint spectrum. It is also noted that while conventional methods such as filtering, windowing, and interpolation can be applied to reduce the sidelobes, such techniques may only provide limited gains under certain conditions. At the same time, the spectrum reconstruction can offer significant gains in the detection performance.

Even though an essential application of the introduced techniques is in the context of sensing integration in future wireless systems, the disclosed algorithms are equally applicable to any radar sensing system that needs to deal with discontinuities in the sensing spectrum. The disclosed techniques can be adopted in different sensing systems, including, but limited to, future wireless systems with integrated communication and sensing operations, such as 6G.

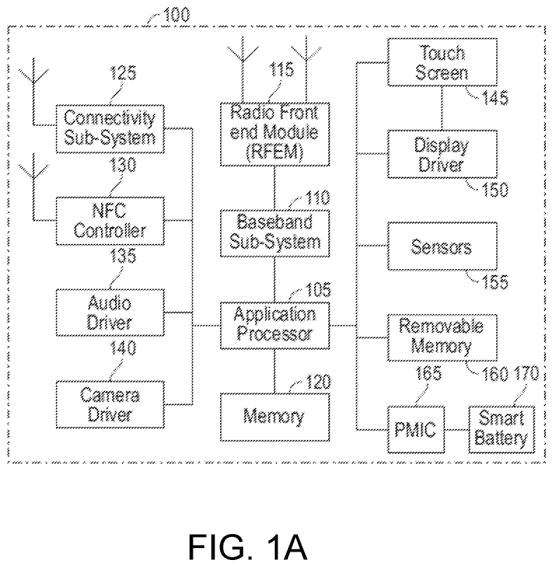

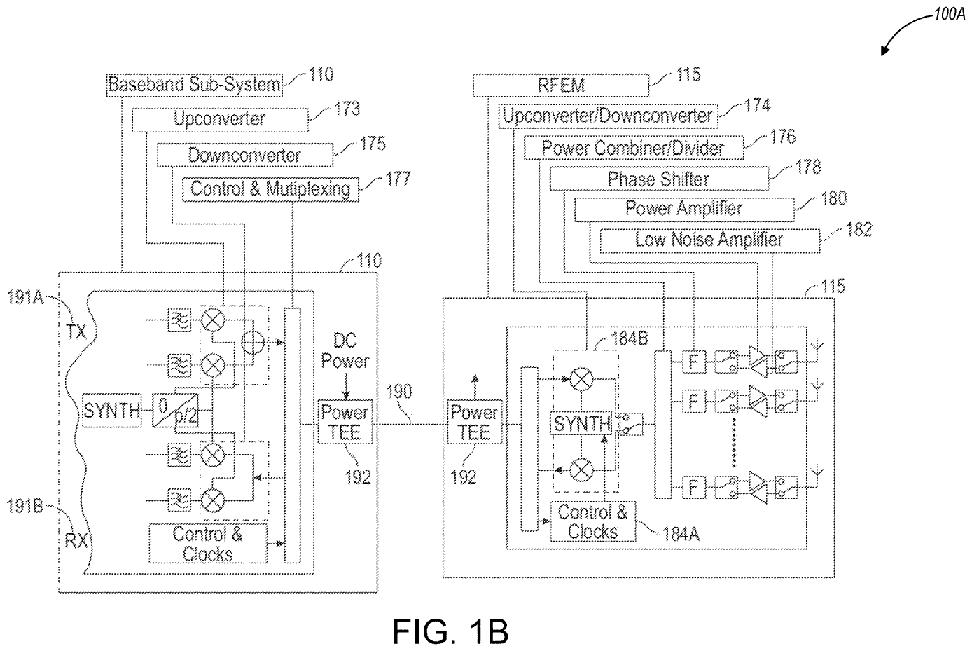

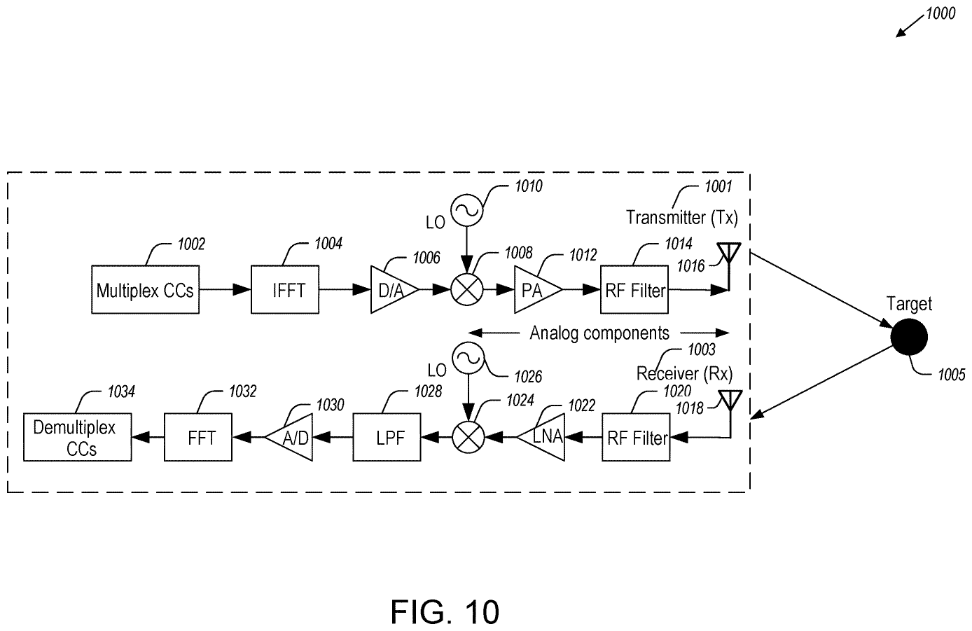

FIGS. 1A-9 and FIG. 19 describe signal processing and communication architectures that can be configured with the disclosed techniques. A more specific description of the disclosed techniques is provided in connection with FIGS. 10-18.

FIG. 1A illustrates an exemplary user device according to some aspects. The device 100 may be a mobile device in some aspects and includes an application processor 105, baseband processor 110 (also referred to as a baseband sub-system), radio front-end module (RFEM) 115, memory 120, connectivity sub-system 125, near field communication (NFC) controller 130, audio driver 135, camera driver 140, touch screen 145, display driver 150, sensors 155, removable memory 160, power management integrated circuit (PMIC) 165, and smart battery 170.

In some aspects, the application processor 105 may include, for example, one or more central processing unit (CPU) cores and one or more of cache memory, low drop-out voltage regulators (LDOs), interrupt controllers, serial interfaces such as SPI, I2C or universal programmable serial interface sub-system, real-time clock (RTC), timer-counters including interval and watchdog timers, general purpose IO, memory card controllers such as SD/MMC or similar, USB interfaces, MIPI interfaces, and/or Joint Test Access Group (JTAG) test access ports.

In some aspects, the baseband processor 110 may be implemented, for example, as a solder-down substrate including one or more integrated circuits, a single packaged integrated circuit soldered to a main circuit board, and/or a multi-chip module including two or more integrated circuits.

Applications of mmWave technology can include, for example, WiGig and future 5G, but the mmWave technology can apply to a variety of telecommunications systems. The mmWave technology can be beneficial for short-range telecommunications systems. WiGig devices operate in the unlicensed 60 GHz band, whereas 5G mmWave is expected to operate initially in the licensed 28 GHz and 39 GHz bands. A block diagram of an example baseband processor 110 and RFEM 115 in a mm Wave system is shown in FIG. 1A.

FIG. 1A illustrates a mmWave system 100A, which can be used in connection with device 100 of FIG. 1A according to some aspects of the present disclosure. The mmWave system 100A includes two components: a baseband processor 110 and one or more radio front-end modules (RFEMs). The RFEM 115 can be connected to the baseband processor 110 by a single cable 190 (e.g., a single coaxial cable), which supplies a modulated intermediate frequency (IF) signal, DC power, clocking signals, and control signals.

The baseband processor 110 is not shown in its entirety, but FIG. 1A instead shows an implementation of the analog front end. This includes a transmitter (TX) section 191A with an upconverter 173 to an intermediate frequency (IF) (around 10 GHz in current implementations), a receiver (RX) section 191B with downconversion 175 from IF to baseband, control and multiplexing circuitry 177 including a combiner to multiplex/demultiplex transmit and receive signals onto a single cable 190. In addition, power tee circuitry 192 (which includes discrete components) is included on the baseband circuit board to provide DC power for the RFEM 115. In some aspects, the combination of the TX section and RX section may be referred to as a transceiver, which may be coupled with one or more antennas or antenna arrays of the types described herein.

The RFEM 115 can be a small circuit board including a number of printed antennas and one or more RF devices containing multiple radio chains, including upconversion/downconversion 174 to millimeter wave frequencies, power combiner/divider 176, programmable phase shifting 178 and power amplifiers (PA) 180, low noise amplifiers (LNA) 182, as well as control and power management circuitry 184A and 184B. This arrangement can be different from Wi-Fi or cellular implementations, which generally have all RF and baseband functionality integrated into a single unit and only antennas connected remotely via coaxial cables.

This architectural difference can be driven by the very large power losses in coaxial cables at millimeter wave frequencies. These power losses can reduce the transmit power at the antenna and reduce receive sensitivity. To avoid this issue, in some aspects, PAs 180 and LNAs 182 may be moved to the RFEM 115 with integrated antennas. In addition, the RFEM 115 may include upconversion/downconversion 174 so that the IF signals over the single cable 190 can be at a lower frequency. Additional system context for mm Wave 5G apparatuses, techniques, and features are discussed herein below.

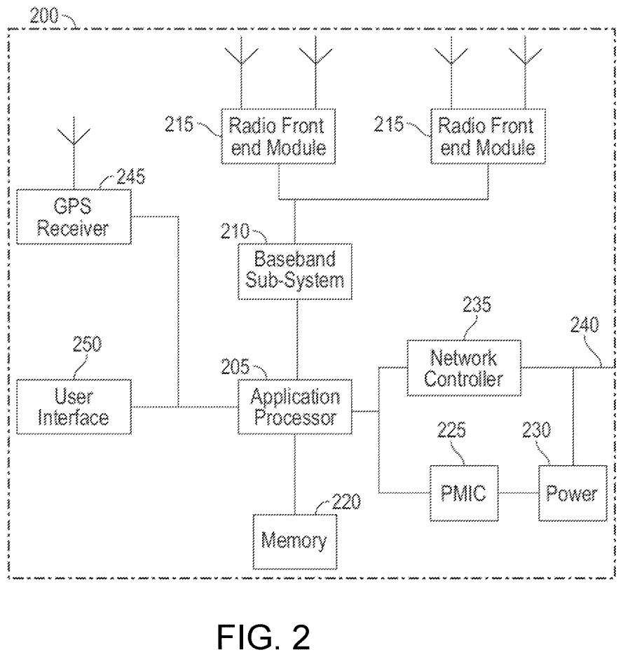

FIG. 2 illustrates an exemplary base station or infrastructure equipment radio head according to some aspects. The base station radio head 200 may include one or more of application processor 205, baseband processors 210, one or more radio front-end modules 215, memory 220, power management integrated circuitry (PMIC) 225, power tee circuitry 230, network controller 235, network interface connector 240, satellite navigation receiver (e.g., GPS receiver) 245, and user interface 250.

In some aspects, the application processor 205 may include one or more CPU cores and one or more of cache memory, low drop-out voltage regulators (LDOs), interrupt controllers, serial interfaces such as SPI, I2C, or universal programmable serial interface, real-time clock (RTC), timer-counters including interval and watchdog timers, general purpose IO, memory card controllers such as SD/MMC or similar, USB interfaces, MIPI interfaces, and Joint Test Access Group (JTAG) test access ports.

In some aspects, baseband processor 210 may be implemented, for example, as a solder-down substrate including one or more integrated circuits, a single packaged integrated circuit soldered to a main circuit board, or a multi-chip sub-system including two or more integrated circuits.

In some aspects, memory 220 may include one or more of volatile memory, including dynamic random access memory (DRAM) and/or synchronous DRAM (SDRAM), and nonvolatile memory (NVM), including high-speed electrically erasable memory (commonly referred to as Flash memory), phase-change random access memory (PRAM), magnetoresistive random access memory (MRAM), and/or a three-dimensional crosspoint memory. Memory 220 may be implemented as one or more of solder-down packaged integrated circuits, socketed memory modules, and plug-in memory cards.

In some aspects, power management integrated circuitry 225 may include one or more of voltage regulators, surge protectors, power alarm detection circuitry, and one or more backup power sources such as a battery or capacitor. Power alarm detection circuitry may detect one or more of brownout (under-voltage) and surge (over-voltage) conditions.

In some aspects, power tee circuitry 230 may provide electrical power drawn from a network cable. Power tee circuitry 230 may provide both power supply and data connectivity to the base station radio head 200 using a single cable.

In some aspects, the network controller 235 may provide connectivity to a network using a standard network interface protocol such as Ethernet. Network connectivity may be provided using a physical connection, which is one of electrical (commonly referred to as copper interconnect), optical, or wireless.

In some aspects, satellite navigation receiver 245 may include circuitry to receive and decode signals transmitted by one or more navigation satellite constellations such as the global positioning system (GPS), Globalnaya Navigatsionnaya Sputnikovaya Sistema (GLONASS), Galileo and/or BeiDou. The satellite navigation receiver 245 may provide, to application processor 205, data which may include one or more of position data or time data. Time data may be used by application processor 205 to synchronize operations with other radio base stations or infrastructure equipment.

In some aspects, user interface 250 may include one or more of buttons. The buttons may include a reset button. User interface 250 may also include one or more indicators such as LEDs and a display screen.

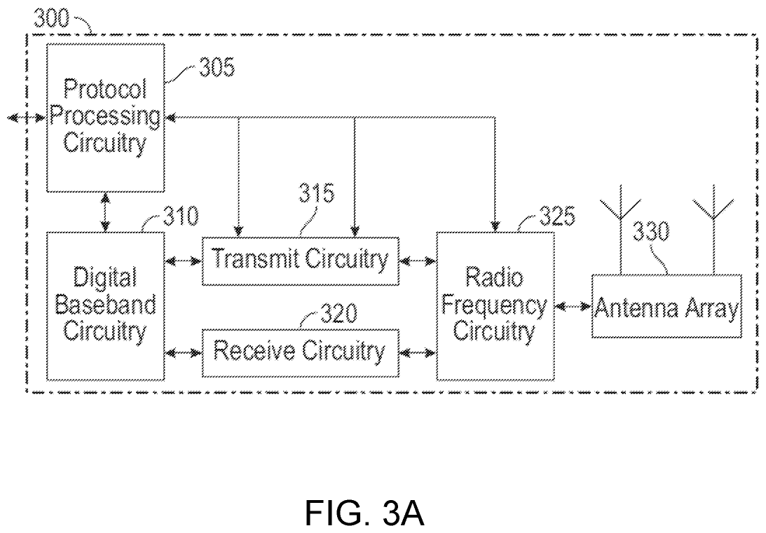

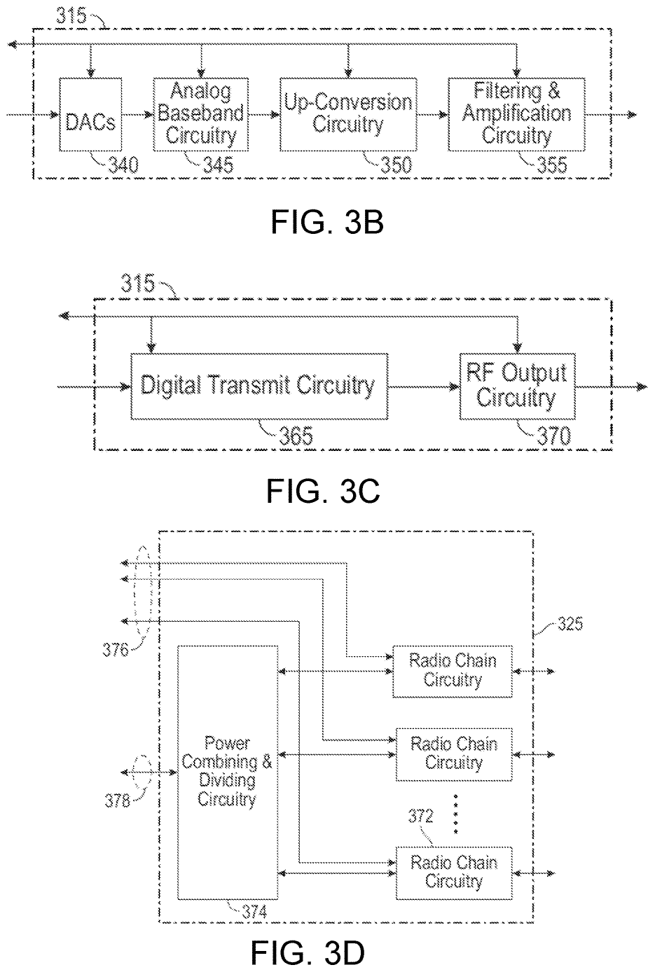

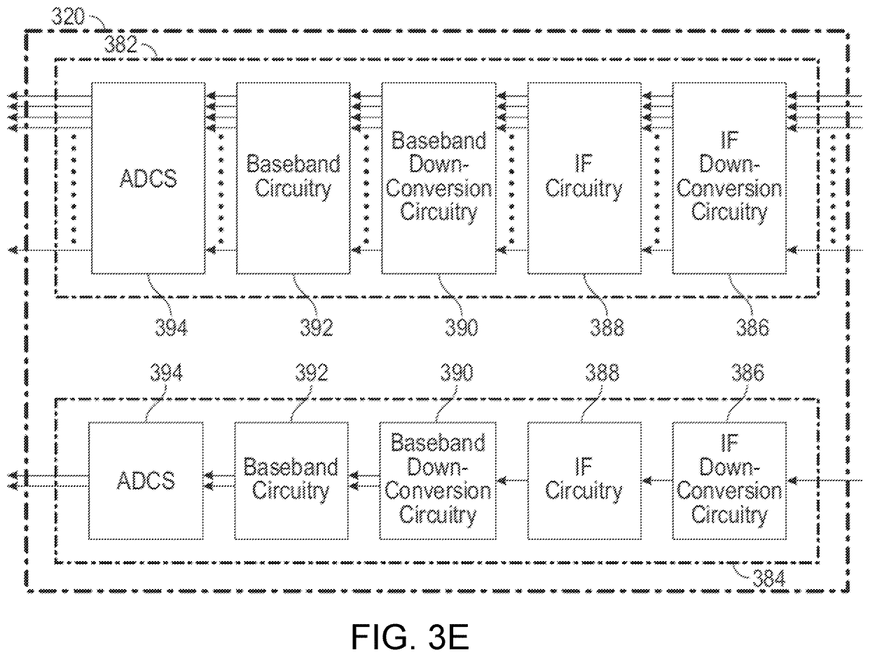

FIG. 3A illustrates exemplary wireless communication circuitry according to some aspects. FIGS. 3B and 3C illustrate aspects of transmit circuitry shown in FIG. 3A according to some aspects. FIG. 3D illustrates aspects of radio frequency circuitry shown in FIG. 3A according to some aspects. FIG. 3E illustrates aspects of receive circuitry in FIG. 3A according to some aspects. Wireless communication circuitry 300, shown in FIG. 3A may be alternatively grouped according to functions. Components illustrated in FIG. 3A are provided here for illustrative purposes and may include other components not shown in FIG. 3A.

Wireless communication circuitry 300 may include protocol processing circuitry 305 (or processor) or other means for processing. Protocol processing circuitry 305 may implement one or more of medium access control (MAC), radio link control (RLC), packet data convergence protocol (PDCP), radio resource control (RRC), and non-access stratum (NAS) functions, among others. Protocol processing circuitry 305 may include one or more processing cores to execute instructions and one or more memory structures to store program and data information.

Wireless communication circuitry 300 may further include digital baseband circuitry 310. Digital baseband circuitry 310 may implement physical layer (PHY) functions, including one or more of hybrid automatic repeat request (HARQ) functions, scrambling and/or descrambling, coding and/or decoding, layer mapping and/or de-mapping, modulation symbol mapping, received symbol and/or bit metric determination, multi-antenna port pre-coding and/or decoding which may include one or more of space-time, space-frequency or spatial coding, reference signal generation and/or detection, preamble sequence generation and/or decoding, synchronization sequence generation and/or detection, control channel signal blind decoding, and other related functions.

Wireless communication circuitry 300 may further include transmit circuitry 315, receive circuitry 320, and/or antenna array circuitry 330. Wireless communication circuitry 300 may further include RF circuitry 325. In some aspects, RF circuitry 325 may include one or multiple parallel RF chains for transmission and/or reception. Each of the RF chains may be connected to one or more antennas of antenna array circuitry 330.

In some aspects, protocol processing circuitry 305 may include one or more instances of control circuitry. The control circuitry may provide control functions for one or more of the digital baseband circuitry 310, transmit circuitry 315, receive circuitry 320, and/or RF circuitry 325.

FIG. 3B and FIG. 3C illustrate aspects of transmit circuitry shown in FIG. 3A according to some aspects. Transmit circuitry 315 shown in FIG. 3B may include one or more of digital to analog converters (DACs) 340, analog baseband circuitry 345, up-conversion circuitry 350, and/or filtering and amplification circuitry 355. DACs 340 may convert digital signals into analog signals. Analog baseband circuitry 345 may perform multiple functions, as indicated below. Up-conversion circuitry 350 may up-convert baseband signals from analog baseband circuitry 345 to RF frequencies (e.g., mmWave frequencies). Filtering and amplification circuitry 355 may filter and amplify analog signals. Control signals may be supplied between protocol processing circuitry 305 and one or more of DACs 340, analog baseband circuitry 345, up-conversion circuitry 350, and/or filtering and amplification circuitry 355.

Transmit circuitry 315 shown in FIG. 3C may include digital transmit circuitry 365 and RF circuitry 370. In some aspects, signals from filtering and amplification circuitry 355 may be provided to digital transmit circuitry 365. As above, control signals may be supplied between protocol processing circuitry 305 and one or more of digital transmit circuitry 365 and RF circuitry 370.

FIG. 3D illustrates aspects of radio frequency circuitry shown in FIG. 3A according to some aspects. RF circuitry 325 may include one or more instances of radio chain circuitry 372, which in some aspects may include one or more filters, power amplifiers, low noise amplifiers, programmable phase shifters, and power supplies.

RF circuitry 325 may also in some aspects, include power combining and dividing circuitry 374. In some aspects, power combining and dividing circuitry 374 may operate bi-directionally, such that the same physical circuitry may be configured to operate as a power divider when the device is transmitting and as a power combiner when the device is receiving. In some aspects, power combining and dividing circuitry 374 may include one or more wholly or partially separate circuitries to perform power dividing when the device is transmitting and power combining when the device is receiving. In some aspects, power combining and dividing circuitry 374 may include passive circuitry, including one or more two-way power divider/combiners arranged in a tree. In some aspects, power combining and dividing circuitry 374 may include active circuitry, including amplifier circuits.

In some aspects, RF circuitry 325 may connect to transmit circuitry 315 and receive circuitry 320 in FIG. 3A. RF circuitry 325 may connect to transmit circuitry 315 and receive circuitry 320 via one or more radio chain interfaces 376 and/or a combined radio chain interface 378. In some aspects, one or more radio chain interfaces 376 may provide one or more interfaces to one or more receive or transmit signals, each associated with a single antenna structure. In some aspects, the combined radio chain interface 378 may provide a single interface to one or more receive or transmit signals, each associated with a group of antenna structures.

FIG. 3E illustrates aspects of receive circuitry in FIG. 3A according to some aspects. Receive circuitry 320 may include one or more parallel receive circuitry 382 and/or one or more combined receive circuitry 384. In some aspects, the one or more parallel receive circuitry 382 and one or more combined receive circuitry 384 may include one or more Intermediate Frequency (IF) down-conversion circuitry 386, IF processing circuitry 388, baseband down-conversion circuitry 390, baseband processing circuitry 392 and analog-to-digital converter (ADC) circuitry 394. As used herein, the term “intermediate frequency” refers to a frequency to which a carrier frequency (or a frequency signal) is shifted as in the intermediate step in transmission, reception, and/or signal processing. IF down-conversion circuitry 386 may convert received RF signals to IF. IF processing circuitry 388 may process the IF signals, e.g., via filtering and amplification. Baseband down-conversion circuitry 390 may convert the signals from IF processing circuitry 388 to baseband. Baseband processing circuitry 392 may process the baseband signals, e.g., via filtering and amplification. ADC circuitry 394 may convert the processed analog baseband signals to digital signals.

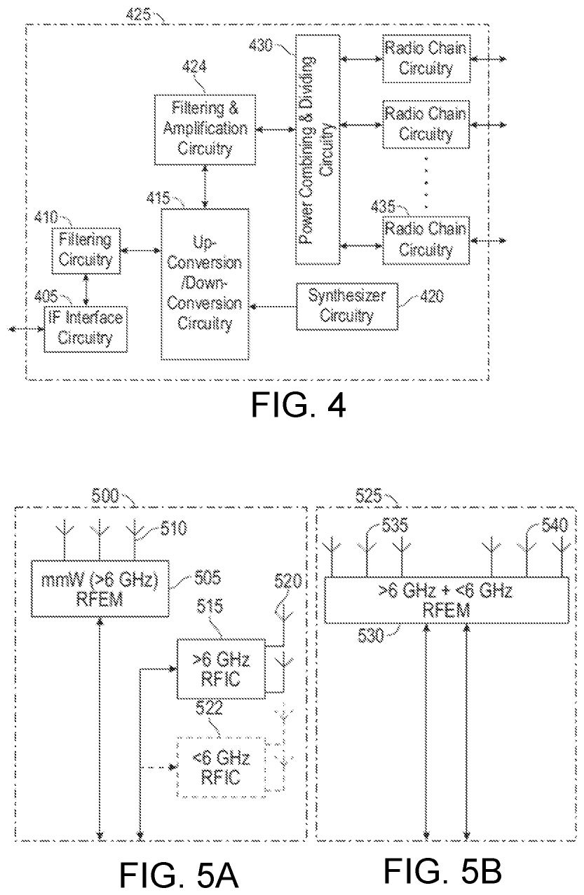

FIG. 4 illustrates exemplary RF circuitry of FIG. 3A according to some aspects. In an aspect, RF circuitry 325 in FIG. 3A (depicted in FIG. 4 using reference number 425) may include one or more of the IF interface circuitry 405, filtering circuitry 410, up-conversion and down-conversion circuitry 415, synthesizer circuitry 420, filtering and amplification circuitry 424, power combining and dividing circuitry 430, and radio chain circuitry 435.

FIG. 5A and FIG. 5B illustrate aspects of a radio front-end module (RFEM) useable in the circuitry shown in FIG. 1A, FIG. 1B and FIG. 2, according to some aspects. FIG. 5A illustrates an aspect of an RFEM according to some aspects. RFEM 500 incorporates a millimeter wave RFEM 505 and one or more above-six gigahertz radio frequency integrated circuits (RFIC) 515 and/or one or more sub-six gigahertz RFICs 522. In this aspect, the one or more sub-six gigahertz RFICs 515 and/or one or more sub-six gigahertz RFICs 522 may be physically separated from millimeter wave RFEM 505. RFICs 515 and 522 may include a connection to one or more antennas 520. RFEM 505 may include multiple antennas 510.

FIG. 5B illustrates an alternate aspect of a radio front-end module 525, according to some aspects. In this aspect, both millimeter wave and sub-six gigahertz radio functions may be implemented in the same physical radio front-end module (RFEM) 530. RFEM 530 may incorporate both millimeter wave antennas 535 and sub-six gigahertz antennas 540.

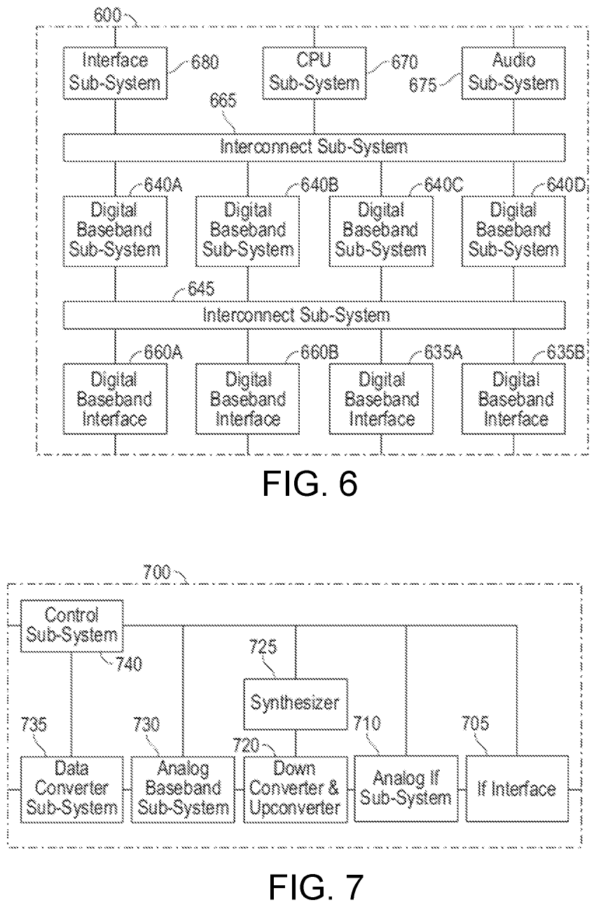

FIG. 6 illustrates a multi-protocol baseband processor 600 that is usable in the system and circuitry shown in FIG. 1A, FIG. 1B or FIG. 2, according to some aspects. In an aspect, a baseband processor may contain one or more digital baseband subsystems 640A, 640B, 640C, and 640D, also herein referred to collectively as digital baseband subsystems.

In an aspect, the one or more digital baseband subsystems 640A, 640B, 640C, and 640D may be coupled via interconnect subsystem 665 to one or more of CPU subsystem 670, audio subsystem 675, and interface subsystem 680. In an aspect, the one or more digital baseband subsystems 640A, 640B, 640C, and 640D may be coupled via interconnect subsystem 645 to one or more of each of digital baseband interface 660A, 660B and mixed-signal baseband subsystem 635A, 635B.

In an aspect, interconnect subsystems 665 and 645 may each include one or more of each of the buses point-to-point connections and network-on-chip (NOC) structures. In an aspect, the audio subsystem 675 may include one or more of digital signal processing circuitry, buffer memory, program memory, speech processing accelerator circuitry, data converter circuitry such as analog-to-digital and digital-to-analog converter circuitry, and analog circuitry including one or more of amplifiers and filters.

FIG. 7 illustrates an exemplary of a mixed signal baseband subsystem 700, according to some aspects. In an aspect, mixed-signal baseband subsystem 700 may include one or more of IF interface 705, analog IF subsystem 710, down-converter and up-converter subsystem 720, analog baseband subsystem 730, data converter subsystem 735, synthesizer 725 and control subsystem 740.

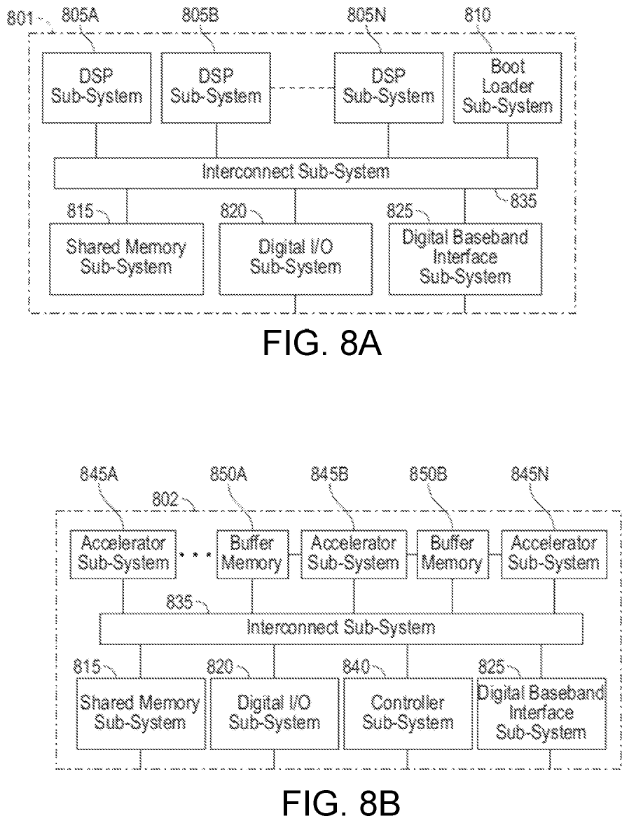

FIG. 8A illustrates a digital baseband processing subsystem 801, according to some aspects. FIG. 8B illustrates an alternate aspect of a digital baseband processing subsystem 802, according to some aspects.

In an aspect of FIG. 8A, the digital baseband processing subsystem 801 may include one or more of each of digital signal processor (DSP) subsystems 805A, 805B, . . . 805N, interconnect subsystem 835, boot loader subsystem 810, shared memory subsystem 815, digital I/O subsystem 820, and digital baseband interface subsystem 825.

In an aspect of FIG. 8B, digital baseband processing subsystem 802 may include one or more of each of accelerator subsystem 845A, 845B, . . . 845N, buffer memory 850A, 850B, . . . 850N, interconnect subsystem 835, shared memory subsystem 815, digital I/O subsystem 820, controller subsystem 840 and digital baseband interface subsystem 825.

In an aspect, boot loader subsystem 810 may include digital logic circuitry configured to perform configuration of the program memory and running state associated with each of the one or more DSP subsystems 805A, 805B . . . 805N. Configuration of the program memory of each of the one or more DSP subsystems 805A, 805B . . . 805N may include loading executable program code from storage external to digital baseband processing subsystems 801 and 802. Configuration of the running state associated with each of the one or more DSP subsystems 805A, 805B . . . 805N may include one or more of the steps of setting the state of at least one DSP core, which may be incorporated into each of the one or more DSP subsystems 805A, 805B . . . 805N to a state in which it is not running, and setting the state of at least one DSP core which may be incorporated into each of the one or more DSP subsystems 805A, 805B . . . 805N into a state in which it begins executing program code starting from a predefined memory location.

In an aspect, shared memory subsystem 815 may include one or more of read-only memory (ROM), static random access memory (SRAM), embedded dynamic random access memory (eDRAM), and/or non-volatile random access memory (NVRAM).

In an aspect, digital I/O subsystem 820 may include one or more of serial interfaces such as Inter-Integrated Circuit (I2C), Serial Peripheral Interface (SPI) or other 1, 2 or 3-wire serial interfaces, parallel interfaces such as general-purpose input-output (GPIO), register access interfaces and direct memory access (DMA). In an aspect, a register access interface implemented in digital I/O subsystem 820 may permit a microprocessor core external to digital baseband processing subsystem 801 to read and/or write one or more of the control and data registers and memory. In an aspect, DMA logic circuitry implemented in digital I/O subsystem 820 may permit the transfer of contiguous blocks of data between memory locations, including memory locations internal and external to digital baseband processing subsystem 801.

In an aspect, digital baseband interface subsystem 825 may provide for the transfer of digital baseband samples between the baseband processing subsystem and mixed-signal baseband or radio-frequency circuitry external to digital baseband processing subsystem 801. In an aspect, digital baseband samples transferred by digital baseband interface subsystem 825 may include in-phase and quadrature (I/Q) samples.

In an aspect, controller subsystem 840 may include one or more of each of the control and status registers and control state machines. In an aspect, control and status registers may be accessed via a register interface and may provide for one or more of starting and stopping operation of control state machines, resetting control state machines to a default state, configuring optional processing features, and/or configuring the generation of interrupts and reporting the status of operations. In an aspect, each of the one or more control state machines may control the sequence of operation of each of the one or more accelerator subsystems 845. There may be examples of implementations of both FIG. 8A and FIG. 8B in the same baseband subsystem.

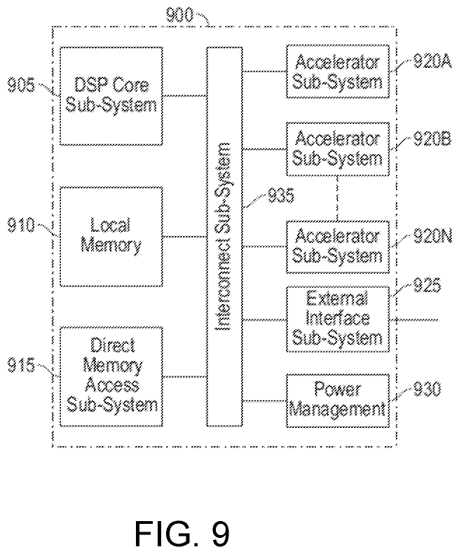

FIG. 9 illustrates a digital signal processor (DSP) subsystem 900 according to some aspects. In an aspect, DSP subsystem 900 may include one or more of each of DSP core subsystem 905, local memory 910, direct memory access (DMA) subsystem 915, accelerator subsystem 920A, 920B . . . 920N, external interface subsystem 925, power management circuitry 930 and interconnect subsystem 935.

In an aspect, the local memory 910 may include one or more of each of read-only memory, static random access memory, or embedded dynamic random access memory.

In an aspect, the DMA subsystem 915 may provide registers and control state machine circuitry adapted to transfer blocks of data between memory locations including memory locations internal and external to DSP subsystem 900.

In an aspect, external interface subsystem 925 may provide for access by a microprocessor system external to DSP subsystem 900 to one or more of memory, control registers, and status registers, which may be implemented in DSP subsystem 900. In an aspect, external interface subsystem 925 may provide for the transfer of data between local memory 910 and storage external to DSP subsystem 900 under the control of one or more of the DMA subsystem 915 and the DSP core subsystem 905.

The disclosed techniques consider a baseband OFDM waveform, with subcarrier spacing of Δf, which carries a block of modulated symbols across disjoint bandwidths located over single or multiple CCs. For the purpose of analysis and without loss of generality, the disclosure focuses on two adjacent CCs—CC₀ and CC₁—such that each CC spans over K subcarriers, starting from subcarrier index 0 for the first CC, and the number of subcarriers in the frequency gap between the CCs is K_{G}. In some aspects, the disclosed techniques can be extended to more CCs and more general setting in terms of the number of subcarriers within each CC and the gaps. The evaluation results below also show the performance of four CCs. In the disclosed signal model, the subcarrier grid is assumed to be fixed for all the CCs (e.g., the RF conversion of CCs is performed using mixers with the exact timing as the OFDM sample clock).

The disclosed techniques consider an environment with multiple targets, each assumed to be a point target with a single-path reflection. This assumption enables a suitable framework to assess the effectiveness of the disclosed techniques.

Further, it can be shown that under the conditions that Doppler migration and scaling do not happen, the Doppler-related term in the sensing channel response influences all the CCs in the same way and does not impact the techniques disclosed in this disclosure. Accordingly, the disclosed techniques only focus on per-symbol processing.

Without loss of generality, monostatic sensing can be considered where the radio signal's transmitter and the receiver of the reflected radio signal are collocated with proper measures to avoid self-interference. However, the disclosed techniques are equally applicable to bi-static sensing. Further, the respective antennas for different CCs are assumed to be the same or collocated, resulting in the same relative target ranges across the CCs.

FIG. 10 illustrates a diagram of a device 1000, including a single transmitter (Tx) radio frequency (RF) and baseband chain 1001, as well as a single receiver (Rx) RF and baseband chain 1003, configured to sense over multiple CCs, according to some aspects. Referring to FIG. 10, the Tx RF and baseband chain 1001 includes multiplexer 1002 (e.g., for CCs), inverse fast Fourier transform (IFFT) 1004, local oscillator (LO) 1010, multiplier 1008, power amplifier (PA) 1012, RF filter 1014, and at least one Tx antenna 1016.

The Rx RF and baseband chain 1003 includes at least one Rx antenna 1018, low-noise amplifier (LNA) 1022, multiplier 1024, LO 1026, analog-to-digital converter (ADC) 1030, fast Fourier transform (FFT) 1032, and demultiplexer 1034.

### Phase Calibration and Group Delay Mismatch Compensation Across Incoherent Disjoint BWs

When transmitting signals over different frequency bands, the achieved timing alignment error across these bands can be due to the group delay response of the PA, the analog components such as filtering in different frequency ranges, and the transmitter calibration error. With the new and ever-improving capabilities of the mixed signal designs, new generations of the transceivers are more likely to allow generating multiple CCs that are closely located on the spectrum (contiguous CCs), using the same RF chain and analog front end (e.g., as illustrated in FIG. 10). This ensures negligible timing error offset, i.e., phase coherency across the aggregated bandwidths, despite possible frequency gaps across the CCs, e.g., due to the specified guard bands, etc. However, sharing a single RF chain to generate the signal over multiple CCs is not always feasible, making coherent processing challenging or impossible.

In some aspects, while the CCs can be assumed as not perfectly coherent, the digital processing of the CCs is still coherent, i.e., all CCs fit into a unified subcarrier grid. However, different RF and analog processing chains for each CC introduce a CC-specific group delay (from the Tx and Rx sides), resulting in phase mismatch across the CCs. In order to bring the CCs into a coherent detection processing framework, it is necessary to compensate for the disparity in group delays at the Rx using the proposed calibration process. Once a coherent set of disjoint bandwidths is available, the wideband processing can treat the intermediate band gaps by the technique disclosed herein.

Referring to FIG. 10, the phase calibration is an initial Rx process only needed at the beginning of the operation and probably at a few later time instances (but not at every sensing frame). The calibration can be achieved by zooming in on a strong high-SNR target (e.g., signal 1005), calculating the offset values across different CCs, and compensating for the delay disparity. Then, only at certain later times does the system fine-tune the offset values. Further, the calibration process can be performed over one or a few symbols to extract the timing offset information and extend it to the rest of the symbols.

For a given CC, considering channel frequency response as a response of a filter, the term “group delay” refers to the first derivative with respect to the frequency of the phase response. The difference between group delays between two CCs indicates the relative time delay between the two CCs.

In some aspects, if different analog processing chains are used for processing each CC, mismatches in RF processing introduce a CC-specific group delay component, i.e., CCs are not coherent, and there is a phase offset across them.

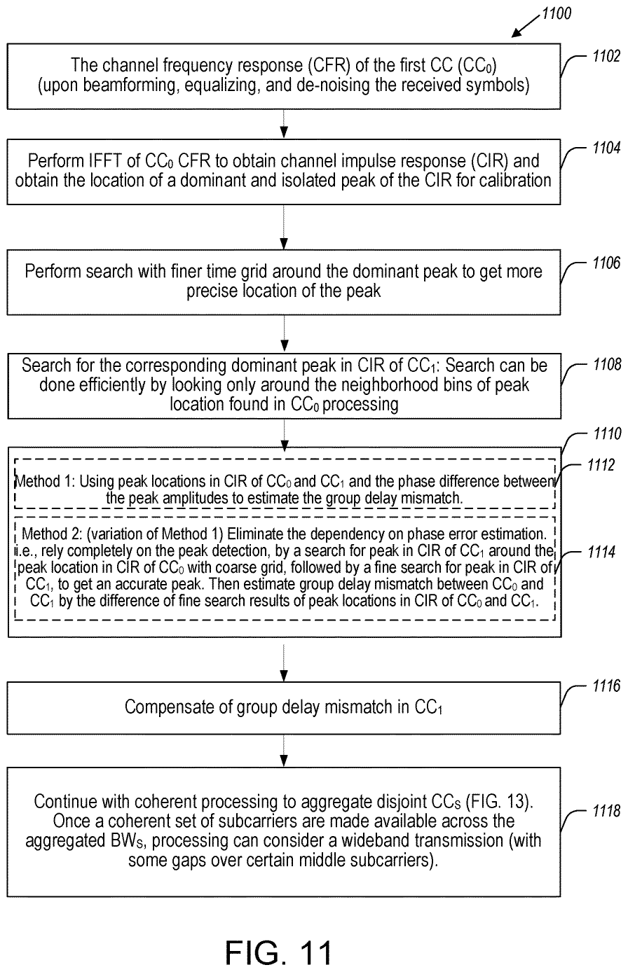

In some aspects, to enable wideband sensing across CCs, the disparity in group delays can be compensated first to make all CCs coherent with each other. This process can be an initial phase calibration. For this purpose, the system can scan the sensing field of view and find a strong, high-SNR target (which is located and isolated enough from other targets) for further processing, as shown in the flow diagram of FIG. 11.

As used herein, the term “dominant peak/echo” means a peak corresponding to a strong target. Since calibration can be performed offline and is not needed per sensing frame, the sensing system can wait for the detection of such a dominant isolated target to perform the calibration.

In some aspects, a channel frequency response (CFR) can be obtained by demodulating receiver frequency domain RX sub-carriers by a known modulation (e.g., Tx-based modulation).

The disclosed techniques are discussed assuming two disjoint BWs labeled CC₀ and CC₁, but the techniques can be similarly extended to more than two BWs (CCs).

FIG. 11 illustrates a flow diagram of method 1100 for phase mismatch and group delay compensation in a non-coherent CCs case, according to some aspects.

At operation 1102, the channel frequency response (CFR) of the first CC (CC0) is calculated (e.g., upon beamforming, equalizing, and de-noising the received symbols).

At operation 1104, IFFT of CC0 CFR is performed to obtain channel impulse response (CIR) and obtain the location of a dominant and isolated peak of the CIR for calibration.

At operation 1106, a search with a finer time grid around the dominant peak is performed to obtain a more precise location of the peak.

At operation 1108, a search for the corresponding dominant peak in CIR of CC1 is performed. In some aspects, the search can be done by considering only the area around the neighborhood bins of the peak location found during the CC0 processing.

At operation 1110, at least two processing techniques can be performed. For example, a first processing technique is performed at operation 1112, based on using peak locations of CC0 and CC1 and the phase difference between the peak amplitudes to estimate the group delay mismatch.

A second processing technique is performed at operation 1114 (which is a variation of operation 1112) based on eliminating the dependency on phase error estimation. For example, only peak detection can be used (e.g., by a search for the peak in CIR of CC1 around the peak location in CIR of CC0 with a coarse grid, followed by a fine search for the peak in CIR of CC1) to obtain an accurate peak. Processing may then continue with estimating the group delay mismatch between CC0 and CC1 by the difference of fine search results of peak locations in CIR of CC0 and CC1.

At operation 1116, group delay mismatch in CC1 can be compensated.

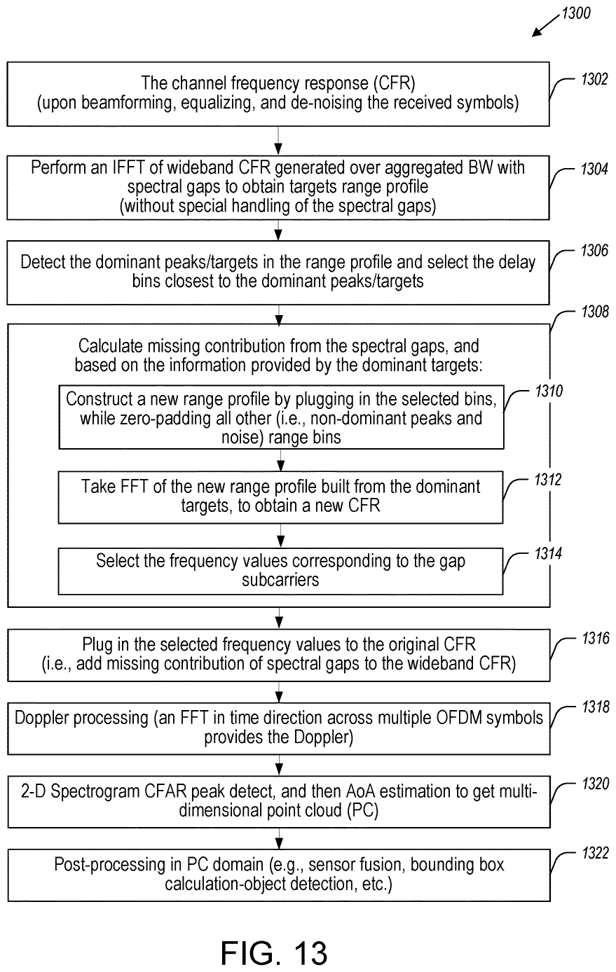

At operation 1118, coherent processing can be performed to aggregate disjoint CCs (e.g., as discussed in connection with FIG. 13). Once a coherent set of subcarriers is made available across the aggregated BWs, processing can consider a wideband transmission (with some gaps over specific middle subcarriers).

A more detailed description of the techniques for phase calibration and group delay mismatch compensation across incoherent disjoint BWs is provided herein below.

The following model description considers a scenario containing L targets with delay and complex amplitudes, with the continuous time representation of the baseband sensing channel for the m'th C denoted

$$by h ( τ , m ) = {\sum }_{l = 0}^{L - 1} {a}_{l} δ ( τ - {τ}_{l} - τ ( m ) ) , m = 0 , 1 , \qquad ( 1 )$$

where aₗ is the complex amplitude for l-th target, τₗ is the round-trip air interface delay for l-th target, and τ(m) is the group delay in the RF chains of the m-th CC, which consists of the respective Tx and Rx components. The goal of the calibration process in the following analysis is to estimate and compensate for τ(1)−τ(0), which can be easily extended to more than two CCs. The frequency domain continuous representation of sensing channel for CC₀ can be derived as follows:

$$\begin{matrix}H ( f , 0 ) = {\int }_{- ∞}^{∞} {\sum }_{l = 0}^{L - 1} {a}_{l} δ ( τ - {τ}_{l} - τ ( 0 ) ) {e}^{- j 2 π f τ} d τ \\ = {\sum }_{l = 0}^{L - 1} {a}_{l} {e}^{- j 2 π f ( {τ}_{l} + τ ( 0 ) )}\end{matrix} . \qquad ( 2 )$$

Assuming all echoes are received within the cyclic prefix of the OFDM symbol, i.e., inter-symbol-interference (ISI)-free received symbols, the OFDM channel estimate is the sampled version of H(f, 0), i.e., for k=0, . . . , K−1, which is represented by:

$$H ( k , 0 ) = {e}^{- j 2 π k Δ f τ ( 0 )} {\sum }_{l = 0}^{L - 1} {a}_{l} {e}^{- j 2 π k Δ f {τ}_{l}} . \qquad ( 3 )$$

By performing an inverse FFT (IFFT) processing of size N, such that N>2K+K_{G}, H(k, 0) is transformed into the time domain at a sample rate high enough to cover both CCs without any ambiguity. The dominant and isolated target can be detected as a target for which the impulse response is separated from other targets by a time delay>>the OFDM sample time

$$T = \frac{1}{N Δ f} .$$

Further, it is also assumed that delay domain isolation covers the range of possible timing errors between the CCs to be compensated for, i.e., the timing error does not lead to the targets' echoes to overlap with each other. As such, the range of the timing errors to be compensated for is first identified to define the requirements for targets isolation.

It is noted that for the calibration process, it is always possible for the sensing node to scan the Field-of-View (FoV) until a target with a range peak within a clean, isolated region is detected. Without loss of generality, it can be assumed that τₗ qualifies such a dominant target. The normalized value of the l′-th target's delay, τ_{l′}+τ(0), to the OFDM sample time is denoted by

$${m}_{{l}^{′} , 0} = \frac{{τ}_{{l}^{′}} + τ ( 0 )}{T} .$$

The time bins closest to τ_{l′}+τ(0), i.e., a neighborhood around m̅_{l′,0}=round (m_{l′,0}), is of interest for further processing. Accordingly, the condition of isolation can be written as |m_{l′,0}−m_{l,0}|>>1 for l′≠l. Next, the IFFT of H(k, 0), is calculated to obtain the complex value of the channel at bin m̅_{l′,0}, as follows:

$$\begin{matrix}h ( {\overline{m}}_{{l}^{′}} , 0 ) = {\sum }_{k = 0}^{K - 1} H ( k , 0 ) {e}^{j 2 π k \frac{{\overline{m}}_{{l}^{′}}}{N}} \\ = {a}_{{l}^{′}} {\sum }_{k = 0}^{K - 1} {e}^{- j 2 π k \frac{( {m}_{{l}^{′}} - {\overline{m}}_{{l}^{′}} )}{N}} + \\ {\sum }_{l = 0 : L - 1 ∖ {l}^{′}} {a}_{l} {\sum }_{k = 0}^{K - 1} {e}^{- j 2 π k \frac{( {m}_{l} - {\overline{m}}_{{l}^{′}} )}{N}} \\ = {K a}_{{l}^{′}} {e}^{- j π ( K - 1 ) \frac{( {m}_{{l}^{′}} - {\overline{m}}_{{l}^{′}} )}{N}} {S}_{\frac{K}{N}} ( {m}_{{l}^{′}} - {\overline{m}}_{{l}^{′}} ) + \\ K {\sum }_{l = 0 : L - 1 ∖ {l}^{′}} {a}_{l} {e}^{- j π ( K - 1 ) \frac{( {m}_{l} - {\overline{m}}_{{l}^{′}} )}{N}} {S}_{\frac{K}{N}} ( {m}_{l} - {\overline{m}}_{{l}^{′}} )\end{matrix} , \qquad ( 4 )$$

where

$${S}_{\frac{K}{N}} ( {Δ}_{m} ) = \frac{sinc \{ \frac{K}{N} ( {Δ}_{m} ) \}}{sinc \{ \frac{{Δ}_{m}}{N} \}} .$$

While the first term in the above summation corresponds to the dominant reflected path (i.e., the dominant target), the rest corresponds to the sum of residual leakage from other targets' echoes to the dominant echo bin. Provided that the isolation condition is met, it can be shown that properties of the function

$${S}_{\frac{K}{N}} ( {Δ}_{m} )$$

ensures that this leakage is low (e.g., ~30 dB weaker than the dominant peak power).

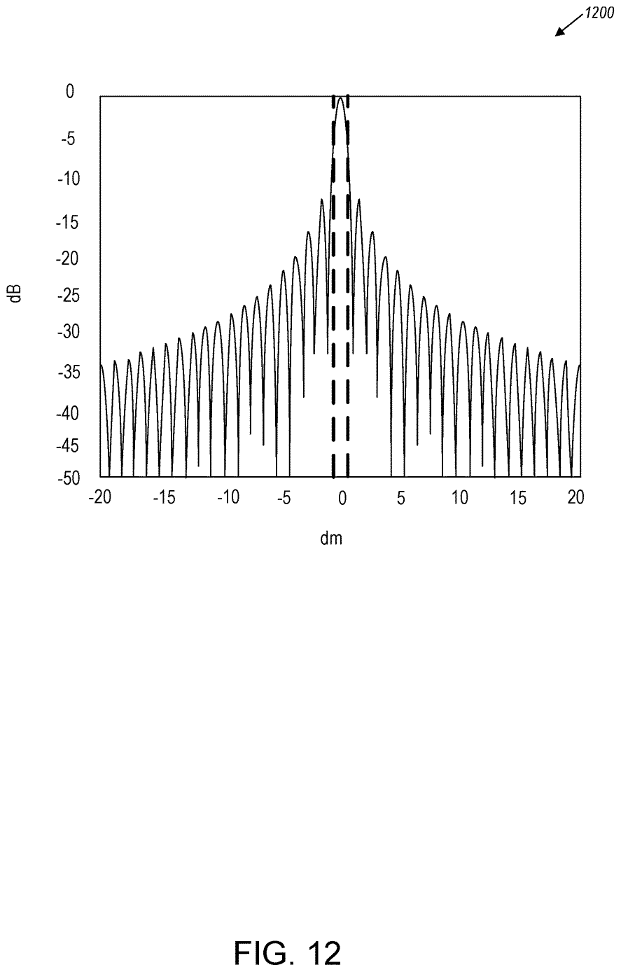

FIG. 12 illustrates a graph 1200 of S_{K/N}(Δₘ) versus Δₘ, according to some aspects.

For 100 MHz bandwidth signal with typical K=3800 and N=4096, FIG. 12 shows the power of S_{K/N}(Δₘ) versus Δₘ. For the dominant echo, Δₘ<0.5, which gives values between the dashed lines (as shown in FIG. 12). For other echoes, assuming they are at least 10 samples away from the dominant echo, the leakage term is attenuated by 30 dB or more.

In this regard, the dominant path can be written as follows:

$$h ( {\overline{m}}_{{l}^{l} , 0} , 0 ) ≅ K {a}_{{l}^{′}} {e}^{- j π ( K - 1 ) \frac{( {m}_{{l}^{′} , 0} - {\overline{m}}_{{l}^{′} , 0} )}{N}} {S}_{\frac{K}{N}} ( {m}_{{l}^{′} , 0} - {\overline{m}}_{{l}^{′} , 0} ) . \qquad ( 5 )$$

Following a similar process for CC₁, for

$$k = K + {K}_{G} , … , 2 K + {K}_{G} - 1 , H ( k , 1 ) = {e}^{j 2 π ( K + {K}_{G} + k ) Δ f τ ( 1 )} {\sum }_{l = 0}^{L - 1} {a}_{l} {e}^{- j 2 π ( K + {K}_{G} + k ) Δ f {τ}_{l}} . \qquad ( 6 )$$

However, instead of calculating the full IFFT for CC₁, it is possible to explore around m̅_{l′,0} to identify the same dominant peak as in CC₀. The range of the delays can be defined to explore around the dominant peak of CC₀ as m∈{m̅_{l′,0}−m₀, m̅_{l′,0}−m₀+1, . . . , m̅_{l′,0}+m₀}. For each bin m, H(k, 1) is then processed to obtain the time domain complex values as follows:

$$\begin{matrix}h ( m , 1 ) = {\sum }_{k = 0}^{K - 1} H ( k , 1 ) {e}^{j 2 π ( K + {K}_{G} + k ) \frac{m}{N}} \\ = {Ka}_{{l}^{′}} {e}^{- j π ( 3 K + 2 {K}_{G} - 1 ) \frac{( {m}_{{l}^{′} , 1} - m )}{N}} {S}_{\frac{K}{N}} ( {m}_{{l}^{′} , 1} - m ) + \\ K {\sum }_{l = 0 : L - 1 ∖ {l}^{′}} {a}_{l} {e}^{- j π ( 3 K + 2 {K}_{G} - 1 ) \frac{( {m}_{l , 1} - m )}{N}} {S}_{\frac{K}{N}} ( {m}_{l , 1} - m )\end{matrix} . \qquad ( 7 )$$

Similar to equation (5), it can be shown that under the isolation condition,

$$h ( m , 1 ) ≅ K {a}_{{l}^{′}} {e}^{- j π ( 3 K + 2 {K}_{G} - 1 ) \frac{( {m}_{{l}^{′} , 1} - m )}{N}} {S}_{\frac{K}{N}} ( {m}_{{l}^{′} , 1} - m ) . \qquad ( 8 )$$

The closest index to the dominant path in CC₁, is then selected as

$${\overline{m}}_{{l}^{l} , 1} = {arg max}_{m} \{ \vert h ( m , 1 ) \vert \} ,$$

which obtains the complex coefficient of the dominant target echo as follows:

$$h ( {\overline{m}}_{{l}^{l} , 1} , 1 ) ≅ {Ka}_{{l}^{′}} {e}^{- j π ( 3 K + 2 {K}_{G} - 1 ) \frac{( {m}_{{l}^{′} , 1} - {\overline{m}}_{{l}^{′} , 1} )}{N}} \times {S}_{\frac{K}{N}} ( {m}_{{l}^{′} , 1} - {\overline{m}}_{{l}^{′} , 1} ) , \qquad ( 9 )$$

where

$$\vert {m}_{{l}^{′} , 1} - {\overline{m}}_{{l}^{′} , 1} \vert < \frac{1}{2} .$$

While the integer part (in steps of T) of the group delay difference between CC₀ and CC₁, is given by m̅_{l′,1}−m̅_{l′,0}, the fractional part is given by the phase difference between the peaks as follows:

$$ϕ ( {CC}_{1} , {CC}_{0} ) = phase \{ h ( {\overline{m}}_{{l}^{′} , 1} , 1 ) \times {h}^{*} ( {\overline{m}}_{{l}^{′} , 0} , 0 ) \} = - π ( 3 K + {K}_{G} - 1 ) \frac{( {m}_{{l}^{′} , 1} - {\overline{m}}_{{l}^{′} , 1} )}{N} + π ( K - 1 ) \frac{( {m}_{{l}^{′} , 0} - {\overline{m}}_{{l}^{′} , 0} )}{N} . \qquad ( 10 )$$

Example methods to perform the phase compensation can be based on the following configurations.

### Method 1 (e.g., Based on Operation 1112 in FIG. 11)

A finer search over CC₀ allows to precisely locate the echo, such that m_{l′,0}≅m̅_{l′,0}, which simplifies equation (10) as follows:

$$ϕ ( {CC}_{1} , {CC}_{0} ) = - π ( 3 K + {K}_{G} - 1 ) \frac{( {m}_{{l}^{′} , 1} - {\overline{m}}_{{l}^{′} , 1} )}{N} . \qquad ( 11 )$$

Accordingly, the delay for the dominant target echo over CC₁ is given by the following equation:

$${m}_{{l}^{′} , 1} = {\overline{m}}_{{l}^{′} , 1} - \frac{ϕ ( C {C}_{1} , {CC}_{0} )}{π} \frac{N}{( 3 K + {K}_{G} - 1 )} , \qquad ( 12 )$$

The group delay mismatch between CC₀ and CC₁ is given by the following equation:

$$τ ( 1 ) - τ ( 0 ) = T ( {m}_{{l}^{′} , 1} - {m}_{{l}^{′} , 0} ) . \qquad ( 13 )$$

The frequency domain channel response of CC₁ is then phase corrected to compensate for τ(1)−τ(0) group delay mismatch, as follows:

$${H}_{coh} ( k , 1 ) = H ( k , 1 ) {e}^{j 2 π ( K + {K}_{G} + k ) \frac{( τ ( 1 ) - τ ( 0 ) )}{T}} , \qquad ( 14 )$$

which then allows applying the bandwidth aggregation techniques for sensing over coherent CCs, as disclosed in the next section.

### Method 2 (e.g., Based on Operation 1114 in FIG. 11)

Method 2 can be considered as a variation of Method 1 and can be used to eliminate the dependency on phase error estimation. i.e., rely completely on the peak detection.

First, an approximate peak in CC0 is detected (e.g., with the IFFT to the accuracy of half sample spacing, T/2). A switch to the individual bin approach for CC0 and a search around the detected peak (in the range of ±T/2) is performed. The location of peak for fine search is denoted as m_{l′,0}.

A search for peak of CC1 is performed with coarse grid m∈

$$\{ {m}_{{l}^{′} , 0} - {m}_{0} , {m}_{{l}^{′} , {0}_{{l}^{′} , 0}} - {m}_{0} + 1 , … , {m}_{{l}^{′} , 0} + {m}_{0} \} .$$

Once the peak location, m̅_{l′,1}, is found, a finer search is performed in the range

$${\overline{m}}_{{l}^{′} , 1} - \frac{1}{2} , and {\overline{m}}_{{l}^{′} , 1} + \frac{1}{2}$$

to obtain the accurate location of the peak, m_{l′,1}. The rest of the algorithm follows Method 1, from equation (13) and onwards.

In some aspects, the CCs (disjoint BWs) are assumed to be coherent (by construction or using previously disclosed calibration). The spectral gaps between CCs introduce discontinuity in full CFR that leads to high sidelobes for range peaks. Dominant range peaks can cause sidelobes that will wipe off weak targets and hence reduce the dynamic range of sensing.

The disclosed techniques address this issue by estimating the receiver radar spectrum (CFR) and plugging in the spectral gaps, as shown in the flow diagram of FIG. 13. The techniques of FIG. 13 can be used for CFR estimation for dominant peaks and reconstruction of the CFR gaps for the full CFR. The calculation of the full range profile can be implemented in the frequency or range domain. The method of FIG. 13 enables sensing processing over one large spectrum (needed to meet the range detection requirements).

FIG. 13 illustrates a flow diagram of method 1300 for spectral gap reconstruction between coherent disjoint bandwidths (BWs), according to some aspects.

At operation 1302, CFR is obtained (e.g., upon beamforming, equalizing, and de-noising the received symbols).

At operation 1304, an IFFT of wideband CFR generated over aggregated BW with spectral gaps is performed to obtain the targets range profile (without special handling of the spectral gaps).

At operation 1306, the dominant peaks/targets in the range profile are detected, and the delay bins closest to the dominant peaks/targets are selected.

At operation 1308, the missing contribution from the spectral gaps is calculated. At operation 1310, based on the information provided by the dominant targets, a new range profile is constructed by plugging in the selected bins while zero-padding all other (i.e., non-dominant peaks and noise) range bins. At operation 1312, the FFT of the new range profile built from the dominant targets is performed to obtain a new CFR. At operation 1314, the frequency values corresponding to the gap subcarriers are selected.

At operation 1316, the selected frequency values are used in the original CFR (i.e., add missing contribution of spectral gaps to the wideband CFR).

At operation 1318, Doppler processing is performed (e.g., an FFT in time direction across multiple OFDM symbols provides the Doppler).

At operation 1320, a 2-D spectrogram is used for CFAR peak detection. AoA estimation is performed to obtain a multi-dimensional point cloud (PC).

At operation 1322, post-processing in the PC domain is performed (e.g., sensor fusion, bounding box calculation-object detection, etc.).

The description below provides an example solution to reduce range sidelobes, assuming the disjoint bandwidths are coherent, either by construction, e.g., using single RF transceiver chains or via the technique proposed in the previous section. In order to lower the range sidelobes due to the spectral gaps in between the aggregated bandwidths, it is desired to reduce the sharpness of the spectral discontinuities caused by the gaps. The following technique estimates and fills in the sensing channel spectrum gaps, hence significantly reducing the spectral discontinuity.

The frequency domain channel response over the aggregated CCs (CC₀ and CC₁), is denoted as follows:

$${H}_{T} ( k ) = \{ \begin{matrix}{H}_{coh} ( k , 0 ) , & k = 0 : K - 1 \\ 0 , & k = K : K + {K}_{G} - 1 \\ {H}_{coh} ( k - K - {K}_{G} , 1 ) & k = K + {K}_{G} : 2 K + {K}_{G} - 1\end{matrix} . \qquad ( 15 )$$

H_{T} can be represented as follows:

$${H}_{T} ( k ) = H ( k ) - H ( k ) \times w ( k ) , \qquad ( 16 )$$

where H(k) is the spectrum without any gap, and w(k) is a frequency window to select the band gap. Note that H(k)×w(k) occupies a much smaller bandwidth compared to H(k). Next, a dominant echo in H(k) can be considered. In H_{T}(k), the same echo has a contribution from H(k), while contaminated by the contribution from H(k)×w(k). However, the contribution from H(k)×w(k) is at lower amplitude and spread over a wider time span due to its narrowband nature. Hence, when the target peak locations of H_{T}(k) are picked with only a few samples on either side of the main peaks, the influence of H(k)× w(k) is largely eliminated when the total bandwidth is much larger than the spectral gap. Hence, when these peaks are converted back to frequency domain, a good approximation of H(k) including the band gaps, is obtained. This idea can be implemented as follows:

$${H}_{T} ( k ) = {\sum }_{l = 0}^{L - 1} {a}_{l} {e}^{- j 2 π k Δ f ( {τ}_{l} )} , \qquad ( 17 )$$

for k=0, 1, . . . , 2K+K_{G}−1. By performing an IFFT of size N>2K+K_{G}−1, the range profile, h_{T}(n), for n=0, . . . , N−1, of the targets is obtained. The dominant targets' echoes in the range profile can be detected. There are various methods for detecting dominant echoes.

In one example of this embodiment, one can calculate the noise floor,

$${σ}_{N}^{2} ,$$

in the range profile first (by averaging the power of a small percentage of lowest value bins in the range profile) and then applying a certain threshold, Pₜₕ, above the noise floor to determine the dominant targets' echoes, i.e., dominant echo at bin n if

$${\vert {h}_{T} ( n ) \vert}^{2} > {P}_{th} \times {σ}_{N}^{2} .$$

Without loss of generality, assume that τ_{l′}, l′=1, . . . , L_{d} qualifies as dominant targets. The delay bins closest to

$${τ}_{{l}^{′}} ( i . e . , {\overline{m}}_{{l}^{′}} = round ( \frac{{τ}_{{l}^{′}}}{T} ) ) ,$$

l′=1, . . . , L_{d} are selected (e.g., the bins with amplitudes up to X % of the peak value, where X can be selected based on the desired performance and complexity). A new range profile, h_{d}(τ), is then constructed by plugging in the selected bins, while zero-padding all other (non-dominant peaks and noise) range bins. By taking the FFT of the new range profile built from the dominant targets, a new frequency domain channel response is obtained as follows:

$${H}_{d} ( f ) = {\int }_{- ∞}^{∞} {h}_{d} ( τ ) {e}^{- j 2 π f τ} d τ . \qquad ( 18 )$$

From this estimated spectrum, frequency values corresponding to the gap subcarriers are selected and replaced in the original frequency channel response H_{T}(k). The new spectrum, H_{T,new}(k) corresponds to the sidelobe reduced range profile as follows:

$${H}_{T , new} ( k ) = \{ \begin{matrix}{H}_{d} ( k ) , & k ∈ gap subcarriers \\ {H}_{T} ( k ) , & otherwise\end{matrix} . \qquad ( 19 )$$

The construction of the new aggregated channel response can be performed in either frequency or time domain, which may result in different computational complexities. Regardless, the prime idea is to estimate and reconstruct the channel corresponding to the gap subcarriers, using the information provided by the dominant peak targets. The new estimated receive channel spectrum H_{T,new}(k) is processed to give a new set of range-Doppler profiles, while the range sidelobes of the dominant targets is significantly lowered. Any target below

$${P}_{th} \times {σ}_{N}^{2}$$

was not included in H_{d}(f) thus will still have discontinuous spectra and so still have high range sidelobes. However, given that these targets result in non-dominant echoes, an appropriate selection of Pₜₕ can ensure these sidelobes are below the noise floor. If needed, and the additional computation is justified to further improve the detection performance and the dynamic range, the process of spectral gap reconstruction can be iterated. However, for many scenarios, even one iteration of the process results in significant sidelobe reduction and improved performance, as will be shown in the next section.

### Simulation Evaluations

In this section, an evaluation of the proposed techniques is presented for a scenario with four CCs, each with 40 MHz bandwidth and subcarrier spacing of 60 kHz, at a carrier frequency of 7 GHz, with band gaps calculated according to the guard-band values in [1, 2]. An environment with two point-targets is considered (e.g., one with a strong echo and one with a weak echo), at distances of 100 m and 110 m relative to the sensing transceiver, both moving at a speed of 100 km/h. A maximum timing mismatch of +/−20 ns between adjacent CCs is considered.

The plots provided in this section, present the range profile extracted at the peak in the Doppler dimension (i.e., a slice through the delay-Doppler profile). This also confirms that applying the proposed techniques at the symbol-level, does not interfere with or disturb the Doppler estimation. Further, in order to show the effectiveness of the proposed algorithms, the case of wide contiguous band covering the entire spectrum with no gaps is evaluated as the reference.

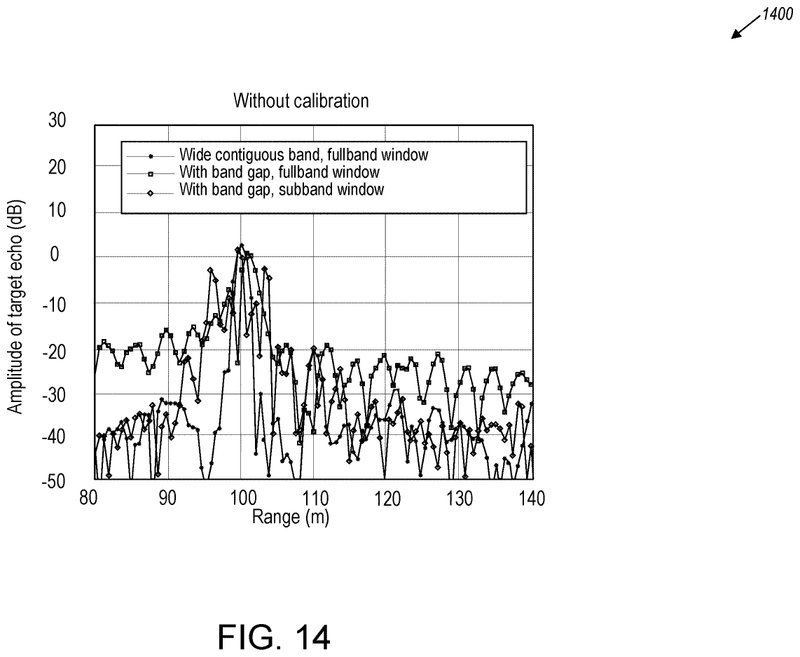

FIG. 14 illustrates graph 1400 of a range profile without calibration and spectral gap reconstruction, according to some aspects. More specifically, FIG. 14 shows the range profile without applying the calibration or spectral gap reconstruction methods. As mentioned earlier, spectral gap reconstruction can only be applied to coherent bandwidth, i.e., for a system with group delay mismatch, it can only be applied after the calibration. Two windowing approaches are compared: 1) applying a full bandwidth window to cover all the four CCs so that the two outer edges of the spectrum is smoothed out; 2) applying individual sub-band windows to each CC, so that each sub-band edge is smoothed out. FIG. 14 shows the broadening of the main lobe of the target echo at 100 m due to the phase mismatch between CCs (for a given echo, CCs contribute to slightly different range and phase, not constructively added at the expected range bin). In addition, the internal band-edges in the full window case cause high sidelobes. With sub-band windows, sidelobes can be lowered, but the main lobe gets even more widened.

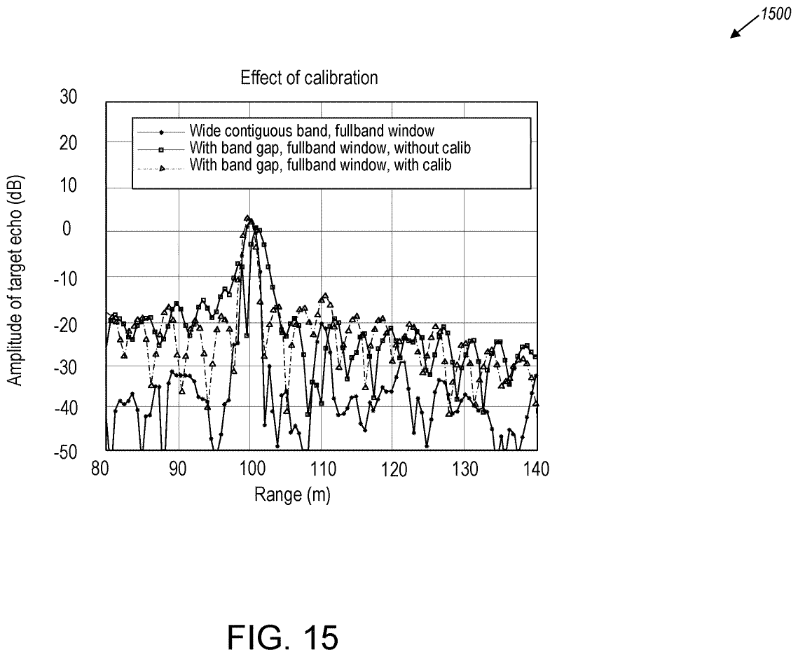

FIG. 15 illustrates graph 1500 of a range profile with calibration and before spectral gap reconstruction, according to some aspects. More specifically, FIG. 15 shows the range profile with calibration before applying the spectral gap reconstruction method. As can be seen in FIG. 15, the main lobe of the main peak is narrowed down to the level of the ideal case (the black curve). However, the effect of band gaps still creates high side lobes.

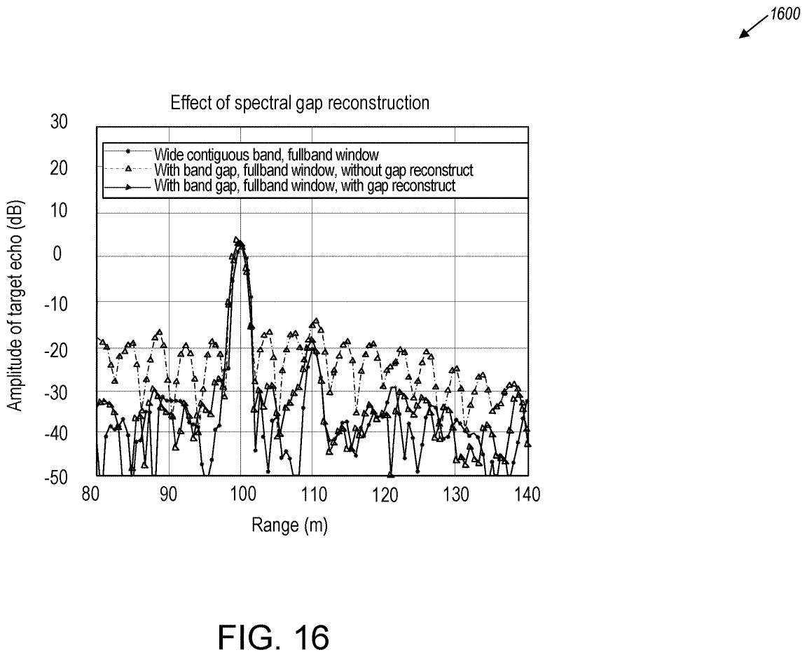

FIG. 16 illustrates graph 1600 of a range profile with calibration and spectral gap reconstruction, according to some aspects. More specifically, FIG. 16 shows that the sidelobe level can be brought down to the level of ideal case with the proposed spectral gap reconstruction algorithm. After the calibration process, the four CCs can be coherently processed, as they constructively contribute to the range profile estimation at the correct range location. With the spectral gap reconstruction, the range spectrum becomes close to the baseline black curve (apart from the contribution from the small targets echoes to the band gaps). This enables achieving a range resolution (related to the main lobe width) and dynamic range (related to the main lobe versus the sidelobe amplitude, i.e., the relative amplitude of the two targets' echoes) close to the case of using a contiguous spectrum with no spectral gaps in between.

To validate this observation statistically, a Monte-Carlo simulations can be performed for the same 4-CC scenario. It is observed that at a detection false alarm rate of ~1%, the reference case of a wide contiguous band achieves a misdetection of 0.05% when the weaker target is at −24.2 dB relative to the stronger target. With disjoint CCs, applying the calibration and spectral gap reconstruction results in performance within ~1 dB of the reference case (i.e., a misdetection of 0.05% is achieved when the weaker target is at −23.1 dB relative to the stronger target). However, without the spectral gap reconstruction, in order to achieve a misdetection of 0.05%, the weaker target needs to be elevated to −14.1 dB relative to the stronger target. This means a 9 dB reduction in the dynamic range for detecting weak targets close to a stronger target.

The remaining slight performance difference between the gap reconstruction and the contiguous band can be further reduced by reapplying the method to the reconstructed wideband channel response (if the added complexity justifies the small gain).

Another scenario can be considered with 4 CCs, each with 100 MHz bandwidth, SCS=60 KHz, at fc=7 GHz, with spectral gaps calculated according to the guard-band values in [1, 2]. The achievable misdetection probability can be compared with and without applying the spectral gap reconstruction technique.

As mentioned earlier, discontinuities in the sensing bandwidth result in increased sidelobes power in the range profile. This leads to increased false alarm probability and reduced detection reliability. It is noted that the specified guard bands in [1, 2] can serve as the minimum spectral gaps between two aggregated CCs. The gap reconstruction technique can also efficiently operate over other gap sizes, where the impact may be more pronounced for larger spectral gaps due to the larger range sidelobes and higher degradation in range detection performance.

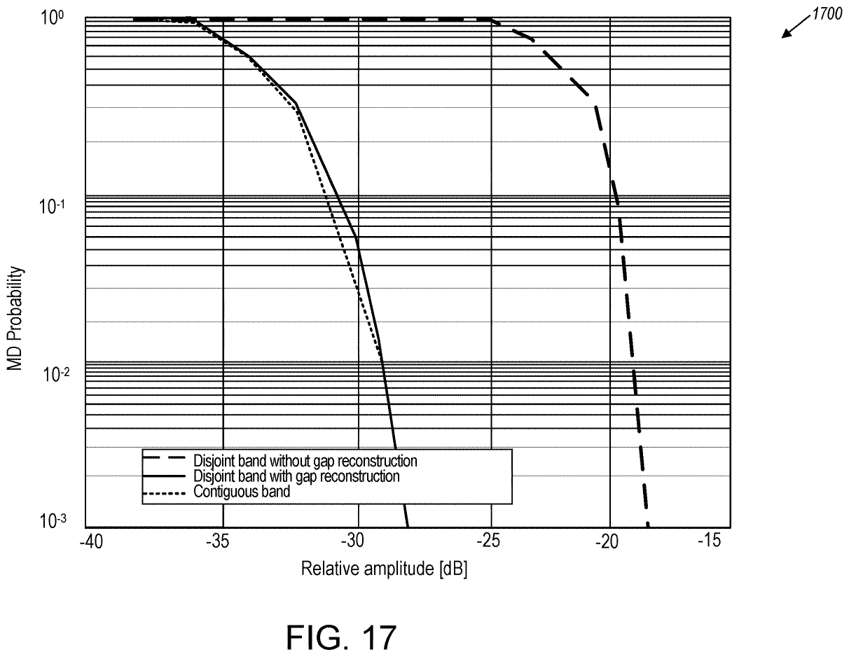

FIG. 17 illustrates graph 1700 of sensing misdetection probability versus the relative amplitude of the two targets, according to some aspects.

In some aspects, a detection algorithm is used with parameters set to achieve CFAR of 10⁻⁵. Monte Carlo simulations can be run for a scenario with two point-targets. FIG. 17 shows the misdetection probability for the weaker target against the relative amplitude of the weaker target with respect to the stronger target. The two targets are at a 10 m range separation. The spectral gap reconstruction method offers ~10 dB improvement in the achievable detection dynamic range for the close-in targets (−18 dB to −28 dB at 10-3 misdetection level) and achieves detection performance very close to the case of wide contiguous bandwidth.

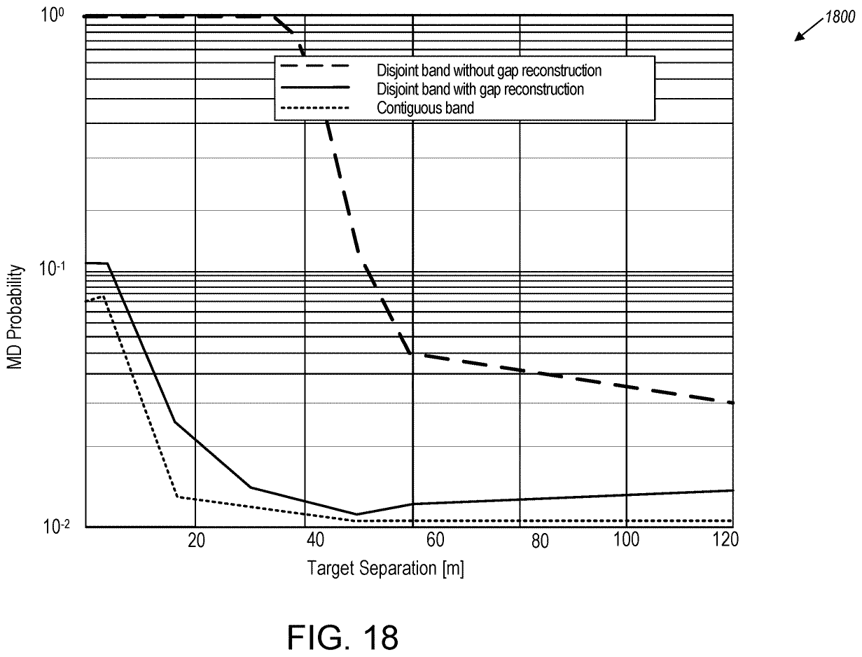

FIG. 18 illustrates a graph 1800 of sensing misdetection probability versus distance difference between the two targets, according to some aspects. More specifically, FIG. 18 shows the misdetection probability vs the range difference between the targets for the weaker target at −29 dB relative to the amplitude of the stronger target. With the spectral gap reconstruction, it is possible to detect the weak target at a closer distance to a strong target than otherwise possible (e.g., <20 m compared to ~55 m in this test case). The detection probability is also improved (~10⁻² versus 4×10⁻²) with the spectral gap reconstruction.

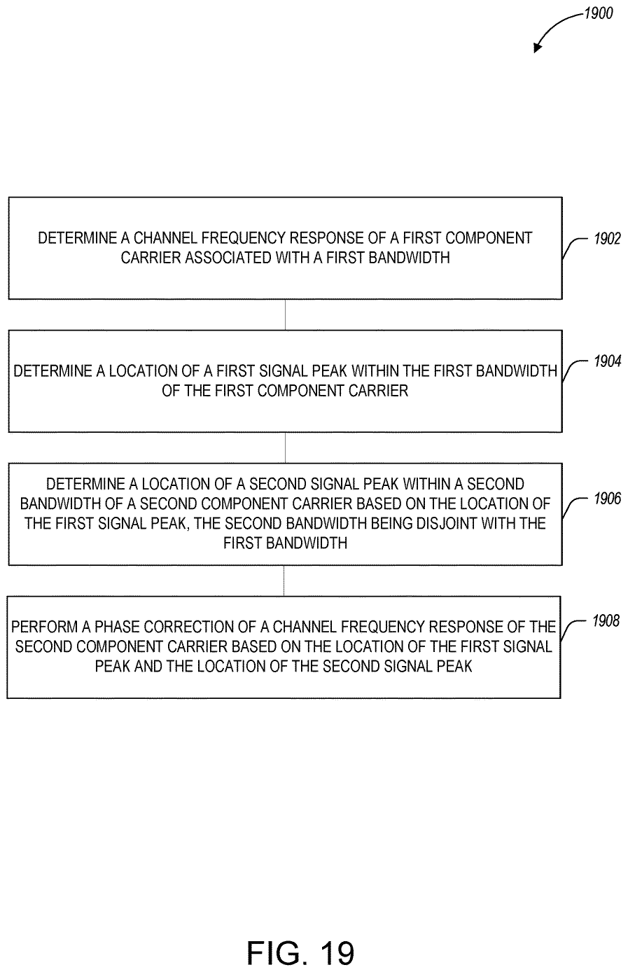

FIG. 19 is a flow diagram illustrating method 1900 for phase correction in a wireless system, in accordance with some aspects. Method 1900 can be performed by processing circuitry of user equipment, a base station, or any other communication device (e.g., communication device 2000). In some aspects, method 1900 is based on the functionalities described in connection with FIG. 10-FIG. 18.

At operation 1902, a channel frequency response of a first component carrier associated with a first bandwidth is determined.

At operation 1904, a location of a first signal peak within the first bandwidth of the first component carrier is determined.

At operation 1906, a location of a second signal peak within a second bandwidth of a second component carrier is determined based on the location of the first signal peak. The second bandwidth is disjoint with the first bandwidth.

At operation 1908, a phase correction of a channel frequency response of the second component carrier is performed based on the location of the first signal peak and the location of the second signal peak.

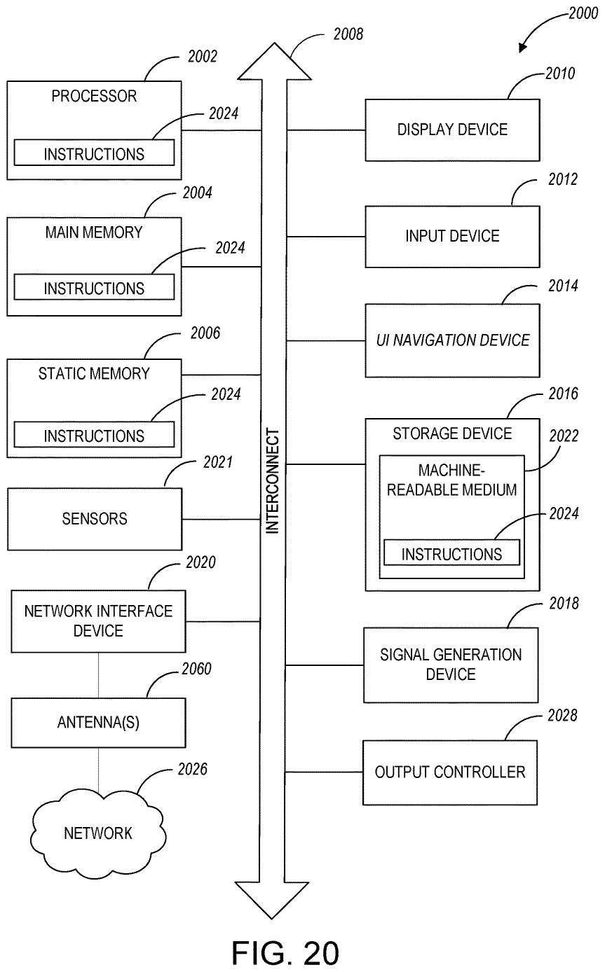

FIG. 20 illustrates a block diagram of a communication device 2000 such as an evolved Node-B (eNB), a new generation Node-B (gNB), an access point (AP), a wireless station (STA), a mobile station (MS), or a user equipment (UE), in accordance with some aspects. In alternative aspects, the communication device 2000 may operate as a standalone device or may be connected (e.g., networked) to other communication devices. In some aspects, the communication device 2000 can use one or more of the techniques and circuits discussed herein in connection with any of FIG. 1A-FIG. 18.

Circuitry (e.g., processing circuitry) is a collection of circuits implemented in tangible entities of the device 2000 that include hardware (e.g., simple circuits, gates, logic, etc.). Circuitry membership may be flexible over time. Circuitries include members that may, alone or in combination, perform specified operations when operating. In an example, the hardware of the circuitry may be immutably designed to carry out a specific operation (e.g., hardwired). In an example, the hardware of the circuitry may include variably connected physical components (e.g., execution units, transistors, simple circuits, etc.), including a machine-readable medium physically modified (e.g., magnetically, electrically, moveable placement of invariant massed particles, etc.) to encode instructions of the specific operation.

In connecting the physical components, the underlying electrical properties of a hardware constituent are changed, for example, from an insulator to a conductor or vice versa. The instructions enable embedded hardware (e.g., the execution units or a loading mechanism) to create members of the circuitry in hardware via the variable connections to carry out portions of the specific operation when in operation. Accordingly, in an example, the machine-readable medium elements are part of the circuitry or are communicatively coupled to the other components of the circuitry when the device is operating. In an example, any of the physical components may be used in more than one member of more than one circuitry. For example, under operation, execution units may be used in a first circuit of a first circuitry at one point in time and reused by a second circuit in the first circuitry or by a third circuit in a second circuitry at a different time. Additional examples of these components with respect to the device 2000 follow.

In some aspects, the device 2000 may operate as a standalone device or may be connected (e.g., networked) to other devices. In a networked deployment, the communication device 2000 may operate in the capacity of a server communication device, a client communication device, or both in server-client network environments. In an example, the communication device 2000 may act as a peer communication device in a peer-to-peer (P2P) (or other distributed) network environment. The communication device 2000 may be a UE, eNB, PC, tablet PC, STB, PDA, mobile telephone, smartphone, a web appliance, a network router, switch or bridge, or any communication device capable of executing instructions (sequential or otherwise) that specify actions to be taken by that communication device. Further, while only a single communication device is illustrated, the term “communication device” shall also be taken to include any collection of communication devices that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms. Modules are tangible entities (e.g., hardware) capable of performing specified operations and may be configured or arranged in a particular manner. In an example, circuits may be arranged (e.g., internally or with respect to external entities such as other circuits) in a specified manner as a module. In an example, the whole or part of one or more computer systems (e.g., a standalone, client, or server computer system) or one or more hardware processors may be configured by firmware or software (e.g., instructions, an application portion, or an application) as a module that operates to perform specified operations. In an example, the software may reside on a communication device-readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

Communication device (e.g., UE) 2000 may include a hardware processor 2002 (e.g., a central processing unit (CPU), a graphics processing unit (GPU), a hardware processor core, or any combination thereof), a main memory 2004, a static memory 2006, and mass storage device 2016 (e.g., hard drive, tape drive, flash storage, or other block or storage devices), some or all of which may communicate with each other via an interlink (e.g., bus) 2008.

The communication device 2000 may further include a display unit 2010, an alphanumeric input device 2012 (e.g., a keyboard), and a user interface (UI) navigation device 2014 (e.g., a mouse). In an example, the display unit 2010, input device 2012 and UI navigation device 2014 may be a touch screen display. The communication device 2000 may additionally include a signal generation device 2018 (e.g., a speaker), a network interface device 2020, and one or more sensors 2021, such as a global positioning system (GPS) sensor, compass, accelerometer, or another sensor. The communication device 2000 may include an output controller 2023, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The mass storage device 2016 may include a communication device-readable medium 2022, on which one or more sets of data structures or instructions 2024 (e.g., software) embodying or utilized by any one or more of the techniques or functions described herein is stored. In some aspects, registers of the processor 2002, the main memory 2004, the static memory 2006, and/or the mass storage device 2016 may be, or include (entirely or at least partially), the device-readable medium 2022, on which is stored the one or more sets of data structures or instructions 2024, embodying or utilized by any one or more of the techniques or functions described herein. In an example, one or any combination of the hardware processor 2002, the main memory 2004, the static memory 2006, or the mass storage device 2016 may constitute the device-readable medium 2022.

As used herein, the term “device-readable medium” is interchangeable with “computer-readable medium” or “machine-readable medium”. While the communication device-readable medium 2022 is illustrated as a single medium, the term “communication device-readable medium” may include a single medium or multiple media (e.g., a centralized or distributed database and/or associated caches and servers) configured to store the one or more instructions 2024.

The term “communication device-readable medium” may include any medium that is capable of storing, encoding, or carrying instructions for execution by the communication device 2000 and that causes the communication device 2000 to perform any one or more of the techniques of the present disclosure, or that is capable of storing, encoding, or carrying data structures used by or associated with such instructions. Non-limiting communication device-readable medium examples may include solid-state memories and optical and magnetic media. Specific examples of communication device-readable media may include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and CD-ROM and DVD-ROM disks. In some examples, communication device-readable media may include non-transitory communication device-readable media. In some examples, communication device-readable media may include communication device-readable media that is not a transitory propagating signal.

The instructions 2024 may further be transmitted or received over a communications network 2026 using a transmission medium via the network interface device 2020 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, a Long Term Evolution (LTE) family of standards, a Universal Mobile Telecommunications System (UMTS) family of standards, peer-to-peer (P2P) networks, among others. In an example, the network interface device 2020 may include one or more physical jacks (e.g., Ethernet, coaxial, or phone jacks) or one or more antennas to connect to the communications network 2026. In an example, the network interface device 2020 may include a plurality of antennas to wirelessly communicate using at least one of single-input multiple-output (SIMO), MIMO, or multiple-input single-output (MISO) techniques. In some examples, the network interface device 2020 may wirelessly communicate using Multiple User MIMO techniques.

While the modules shown in FIG. 20 are depicted as separate blocks within the communication device 2000, the functions performed by some of these blocks may be integrated within a single semiconductor circuit or may be implemented using two or more separate integrated circuits.

The term “transmission medium” shall be taken to include any intangible medium that is capable of storing, encoding, or carrying instructions for execution by the communication device 2000 and includes digital or analog communications signals or other intangible medium to facilitate communication of such software. In this regard, a transmission medium in the context of this disclosure is a device-readable medium.

Discussions herein utilizing terms such as “processing,” “computing,” “calculating,” “determining,” “establishing,” “analyzing,” “checking,” or the like may refer to operation(s) and/or process(es) of a computer, a computing platform, a computing system, or other electronic computing devices, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” and “a plurality,” as used herein, include, for example, “multiple” or “two or more.” For example, “a plurality of items” includes two or more items.

References to “one aspect,” “an aspect,” “an example aspect,” “some aspects,” “demonstrative aspect,” “various aspects,” etc., indicate that the aspect(s) so described may include a particular feature, structure, or characteristic, but not every aspect necessarily includes the particular feature, structure, or characteristic. Further, repeated use of the phrase “in one aspect” does not necessarily refer to the same aspect, although it may.

As used herein, unless otherwise specified, the use of the ordinal adjectives “first,” “second,” “third,” etc., to describe a common object merely indicates that different instances of like objects are being referred to and are not intended to imply that the objects so described must be in a given sequence, either temporally, spatially, in ranking, or any other manner.

Some aspects may be used in conjunction with various devices and systems, for example, a User Equipment (UE), a Mobile Device (MD), a wireless station (STA), a Personal Computer (PC), a desktop computer, a mobile computer, a laptop computer, a notebook computer, a tablet computer, a server computer, a handheld computer, a sensor device, an Internet of Things (IoT) device, a wearable device, a handheld device, a Personal Digital Assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless Access Point (AP), a wired or wireless router, a wired or wireless modem, a video device, an audio device, an audio-video (A/V) device, a wired or wireless network, a wireless area network, a Wireless Video Area Network (WVAN), a Local Area Network (LAN), a Wireless LAN (WLAN), a Personal Area Network (PAN), a Wireless PAN (WPAN), and the like.

Some aspects may, for example, be used in conjunction with devices and/or networks operating in accordance with existing IEEE 802.11 standards (including IEEE 802.11-2016 (IEEE 802.11-2016, IEEE Standard for Information technology—Telecommunications and information exchange between systems Local and metropolitan area networks—Specific requirements Part 11: Wireless LAN Medium Access Control (MAC) and Physical Layer (PHY) Specifications, Dec. 7, 2016); IEEE 802.11ay (P802.11ay Standard for Information Technology—Telecommunications and Information Exchange Between Systems Local and Metropolitan Area Networks—Specific Requirements Part 11: Wireless LAN Medium Access Control (MAC) and Physical Layer (PHY) Specifications—Amendment: Enhanced Throughput for Operation in License-Exempt Bands Above 45 GHz)) and/or future versions and/or derivatives thereof, devices and/or networks operating in accordance with existing WiFi Alliance (WFA) Peer-to-Peer (P2P) specifications (including WiFi P2P technical specification, version 1.5, Aug. 4, 2015) and/or future versions and/or derivatives thereof, devices and/or networks operating in accordance with existing Wireless-Gigabit-Alliance (WGA) specifications (including Wireless Gigabit Alliance, Inc WiGig MAC and PHY Specification Version 1.1, April 2011, Final specification) and/or future versions and/or derivatives thereof, devices and/or networks operating in accordance with existing cellular specifications and/or protocols, e.g., 3rd Generation Partnership Project (3GPP), 3GPP Long Term Evolution (LTE) and/or future versions and/or derivatives thereof, units and/or devices which are part of the above networks, and the like.

Some aspects may be used in conjunction with one-way and/or two-way radio communication systems, cellular radiotelephone communication systems, a mobile phone, a cellular telephone, wireless telephone, a Personal Communication Systems (PCS) device, a PDA device that incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, e.g., a Smartphone, a Wireless Application Protocol (WAP) device, or the like.

Some aspects may be used in conjunction with one or more types of wireless communication signals and/or systems, for example, Radio Frequency (RF), Infra-Red (IR), Frequency-Division Multiplexing (FDM), Orthogonal FDM (OFDM), Orthogonal Frequency-Division Multiple Access (OFDMA), Spatial Divisional Multiple Access (SDMA), FDM Time-Division Multiplexing (TDM), Time-Division Multiple Access (TDMA), Multi-User MIMO (MU-MIMO), Extended TDMA (E-TDMA), General Packet Radio Service (GPRS), extended GPRS, Code-Division Multiple Access (CDMA), Wideband CDMA (WCDMA), CDMA 2000, single-carrier CDMA, multi-carrier CDMA, Multi-Carrier Modulation (MDM), Discrete Multi-Tone (DMT), Bluetooth, Global Positioning System (GPS), Wi-Fi, Wi-Max, ZigBee™, Ultra-Wideband (UWB), Global System for Mobile communication (GSM), 2G, 2.5G, 3G, 3.5G, 4G, Fifth Generation (5G) mobile networks, 3GPP, Long Term Evolution (LTE), LTE advanced, Enhanced Data rates for GSM Evolution (EDGE), or the like. Other aspects may be used in various other devices, systems, and/or networks.

The term “wireless device,” as used herein, includes, for example, a device capable of wireless communication, a communication device capable of wireless communication, a communication station capable of wireless communication, a portable or non-portable device capable of wireless communication, or the like. In some demonstrative aspects, a wireless device may be or may include a peripheral that is integrated with a computer or a peripheral that is attached to a computer. In some demonstrative aspects, the term “wireless device” may optionally include a wireless service.

The term “communicating,” as used herein with respect to a communication signal, includes transmitting the communication signal and/or receiving the communication signal. For example, a communication unit that is capable of communicating a communication signal may include a transmitter to transmit the communication signal to at least one other communication unit and/or a communication receiver to receive the communication signal from at least one other communication unit. The verb communicating may be used to refer to the action of transmitting and/or the action of receiving. In one example, the phrase “communicating a signal” may refer to the action of transmitting the signal by a first device and may not necessarily include the action of receiving the signal by a second device. In another example, the phrase “communicating a signal” may refer to the action of receiving the signal by a first device and may not necessarily include the action of transmitting the signal by a second device.

Some demonstrative aspects may be used in conjunction with a wireless communication network communicating over a frequency band above 45 Gigahertz (GHz), e.g., 60 GHz. However, other aspects may be implemented utilizing any other suitable wireless communication frequency bands, for example, an Extremely High Frequency (EHF) band (the millimeter wave (mmWave) frequency band), e.g., a frequency band within the frequency band between 20 GHz and 300 GHz, a frequency band above 45 GHz, a frequency band below 20 GHz, e.g., a Sub 1 GHz (S1G) band, a 2.4 GHz band, a 5 GHz band, a WLAN frequency band, a WPAN frequency band, a frequency band according to the WGA specification, and the like.

As used herein, the term “circuitry” may, for example, refer to, be part of, or include an Application Specific Integrated Circuit (ASIC), an integrated circuit, an electronic circuit, a processor (shared, dedicated, or group), and/or memory (shared, dedicated, or group), that execute one or more software or firmware programs, a combinational logic circuit, and/or other suitable hardware components that provide the described functionality. In some aspects, circuitry may include logic, at least partially operable in hardware. In some aspects, the circuitry may be implemented as part of and/or in the form of a radio virtual machine (RVM), for example, as part of a Radio processor (RP) configured to execute code to configure one or more operations and/or functionalities of one or more radio components.

The term “logic” may refer, for example, to computing logic embedded in the circuitry of a computing apparatus and/or computing logic stored in the memory of a computing apparatus. For example, the logic may be accessible by a processor of the computing apparatus to execute the computing logic to perform computing functions and/or operations. In one example, logic may be embedded in various types of memory and/or firmware, e.g., silicon blocks of various chips and/or processors. Logic may be included in and/or implemented as part of various circuitry, e.g., radio circuitry, receiver circuitry, control circuitry, transmitter circuitry, transceiver circuitry, processor circuitry, and/or the like. In one example, logic may be embedded in volatile memory and/or non-volatile memory, including random access memory, read-only memory, programmable memory, magnetic memory, flash memory, persistent memory, and/or the like. Logic may be executed by one or more processors using memory, e.g., registers, buffers, stacks, and the like, coupled to the one or more processors, e.g., as necessary to execute the logic.

The term “antenna” or “antenna array,” as used herein, may include any suitable configuration, structure, and/or arrangement of one or more antenna elements, components, units, assemblies, and/or arrays. In some aspects, the antenna may implement transmit and receive functionalities using separate transmit and receive antenna elements. In some aspects, the antenna may implement transmit and receive functionalities using common and/or integrated transmit/receive elements. The antenna may include, for example, a phased array antenna, a single element antenna, a set of switched beam antennas, and/or the like.

Additional examples of the presently described method, system, and device embodiments include the following non-limiting implementations. Each of the following non-limiting examples may stand on its own or may be combined in any permutation or combination with any one or more of the other examples provided below or throughout the present disclosure.

Example 1 is an apparatus comprising one or more antennas and transceiver circuitry coupled to the one or more antennas, the transceiver circuitry comprising receiver circuitry and transmitter circuitry, and the transceiver circuitry to determine a channel impulse response of a first component carrier associated with a first bandwidth; determine a location of a first impulse response peak within the first bandwidth; determine a location of a second impulse response peak within a second bandwidth associated with the first component carrier or with a second component carrier based on the location of the first impulse response peak, the second bandwidth being disjoint with the first bandwidth; and perform a phase correction of one of a channel frequency response of the first bandwidth and a channel frequency response of the second bandwidth based on the first impulse response peak and the second impulse response peak.

In Example 2, the subject matter of Example 1 includes subject matter where the transceiver circuitry is further to determine a phase difference between the first impulse response peak and the second impulse response peak.

In Example 3, the subject matter of Example 2 includes subject matter where the transceiver circuitry is further to estimate a group delay difference between the first bandwidth and the second bandwidth based on the location of the first impulse response peak, the location of the second impulse response peak, and the phase difference between the first impulse response peak and the second impulse response peak.

In Example 4, the subject matter of Example 3 includes subject matter where the transceiver circuitry is further to estimate a phase difference between a channel frequency response of the first bandwidth and a channel frequency response of the second bandwidth based on the group delay difference.

In Example 5, the subject matter of Example 4 includes subject matter where the transceiver circuitry is further to perform the phase correction of one of the channel frequency response of the first bandwidth and the channel frequency response of the second bandwidth based on the first impulse response peak and the second impulse response peak based on the estimated phase difference between the channel frequency response of the first bandwidth and the channel frequency response of the second bandwidth.

In Example 6, the subject matter of Examples 1-5 includes subject matter where the transceiver circuitry is further to perform an inverse fast Fourier transform (IFFT) of the first bandwidth to determine a dominant peak for an impulse response of the first bandwidth.

In Example 7, the subject matter of Example 6 includes subject matter where the transceiver circuitry is further to perform a search with a fine time grid around the dominant peak to determine the location of the first impulse response peak.

In Example 8, the subject matter of Example 7 includes subject matter where the transceiver circuitry is further to perform a coarse grid search within an area of the first impulse response peak to obtain coarse grid search results associated with the second impulse response peak.

In Example 9, the subject matter of Example 8 includes subject matter where the transceiver circuitry is further to perform a fine grid search within the area of the second impulse response peak to obtain fine grid search results associated with the second impulse response peak; determine the second impulse response peak based on the fine grid search results; determine a group delay mismatch between the first bandwidth and the second bandwidth based on a difference between the search for the first impulse response peak and the fine grid search results; and perform the phase correction based on the group delay mismatch.

Example 10 is a method for phase correction, the method comprising determining a channel impulse response of a first component carrier associated with a first bandwidth; determining a location of a first impulse response peak within the first bandwidth; determining a location of a second impulse response peak within a second bandwidth associated with the first component carrier or with a second component carrier based on the location of the first impulse response peak, the second bandwidth being disjoint with the first bandwidth; and performing a phase correction of one of a channel frequency response of the first bandwidth and a channel frequency response of the second bandwidth based on the first impulse response peak and the second impulse response peak.

In Example 11, the subject matter of Example 10 includes determining a phase difference between the first impulse response peak and the second impulse response peak.

In Example 12, the subject matter of Example 11 includes estimating a group delay difference between the first bandwidth and the second bandwidth based on the location of the first impulse response peak, the location of the second impulse response peak, and the phase difference between the first impulse response peak and the second impulse response peak; estimating a phase difference between a channel frequency response of the first bandwidth and a channel frequency response of the second bandwidth based on the group delay difference; and performing the phase correction of one of the channel frequency response of the first bandwidth and the channel frequency response of the second bandwidth based on the first impulse response peak and the second impulse response peak based on the estimated phase difference between the channel frequency response of the first bandwidth and the channel frequency response of the second bandwidth.

Example 13 is a computer-readable storage medium that stores instructions for execution by one or more processors of a communication device, the instructions to configure the communication device for signal detection with multiple carrier components with phase mismatch and band gaps between them, and to cause the communication device to: determine a channel impulse response of a first component carrier associated with a first bandwidth; determine a location of a first impulse response peak within the first bandwidth; determine a location of a second impulse response peak within a second bandwidth associated with the first component carrier or with a second component carrier based on the location of the first impulse response peak, the second bandwidth being disjoint with the first bandwidth; and perform a phase correction of one of a channel frequency response of the first bandwidth and a channel frequency response of the second bandwidth based on the first impulse response peak and the second impulse response peak.

In Example 14, the subject matter of Example 13 includes subject matter where the instructions further cause the communication device to determine a phase difference between the first impulse response peak and the second impulse response peak.

In Example 15, the subject matter of Example 14 includes subject matter where the instructions further cause the communication device to estimate a group delay difference between the first bandwidth and the second bandwidth based on the location of the first impulse response peak, the location of the second impulse response peak, and the phase difference between the first impulse response peak and the second impulse response peak.

In Example 16, the subject matter of Example 15 includes subject matter where the instructions further cause the communication device to estimate a phase difference between a channel frequency response of the first bandwidth and a channel frequency response of the second bandwidth based on the group delay difference.

In Example 17, the subject matter of Example 16 includes subject matter where the instructions further cause the communication device to perform the phase correction of one of the channel frequency response of the first bandwidth and the channel frequency response of the second bandwidth based on the first impulse response peak and the second impulse response peak based on the estimated phase difference between the channel frequency response of the first bandwidth and the channel frequency response of the second bandwidth.

In Example 18, the subject matter of Examples 13-17 includes subject matter where the instructions further cause the communication device to perform an inverse fast Fourier transform (IFFT) of the first bandwidth to determine a dominant peak for an impulse response of the first bandwidth.

In Example 19, the subject matter of Example 18 includes subject matter where the instructions further cause the communication device to perform a search with a fine time grid around the dominant peak to determine the location of the first impulse response peak.

In Example 20, the subject matter of Example 19 includes subject matter where the instructions further cause the communication device to perform a coarse grid search within an area of the first impulse response peak to obtain coarse grid search results associated with the second impulse response peak; perform a fine grid search within the area of the second impulse response peak to obtain fine grid search results associated with the second impulse response peak; determine the second impulse response peak based on the fine grid search results; determine a group delay mismatch between the first bandwidth and the second bandwidth based on a difference between the search for the first impulse response peak and the fine grid search results; and perform the phase correction based on the group delay mismatch.

Example 21 is an apparatus comprising: one or more antennas; and transceiver circuitry coupled to the one or more antennas, the transceiver circuitry comprising receiver circuitry and transmitter circuitry, and the transceiver circuitry to: determine a channel impulse response of a first component carrier associated with a first bandwidth; determine a location of a first impulse response peak within the first bandwidth; determine a location of a second impulse response peak within a second bandwidth associated with the first component carrier or with a second component carrier based on the location of the first impulse response peak, the second bandwidth being disjoint with the first bandwidth; determine a phase difference between the first impulse response peak and the second impulse response peak; estimate a group delay difference between the first bandwidth and the second bandwidth based on the location of the first impulse response peak, the location of the second impulse response peak, and the phase difference between the first impulse response peak and the second impulse response peak; estimate a phase difference between a channel frequency response of the first bandwidth and a channel frequency response of the second bandwidth based on the group delay difference; and perform a phase correction of one of the channel frequency responses of the first bandwidth and the second bandwidth based on the estimated phase difference between the channel frequency response of the first bandwidth and the channel frequency response of the second bandwidth.

Example 22 is an apparatus comprising: one or more antennas; and transceiver circuitry coupled to the one or more antennas, the transceiver circuitry comprising receiver circuitry and transmitter circuitry, and the transceiver circuitry to: determine a channel impulse response of a first component carrier associated with a first bandwidth; determine a location of a first impulse response peak within the first bandwidth; determine a location of a second impulse response peak within a second bandwidth associated with the first component carrier or with a second component carrier based on the location of the first impulse response peak, the second bandwidth being disjoint with the first bandwidth; perform a first fine grid search within an area of the first impulse response peak to obtain a first fine location associated with the first impulse response peak; perform a second fine grid search within an area of the second impulse response peak to obtain a second fine location associated with the second impulse response peak; estimate a group delay difference between the first bandwidth and the second bandwidth based on the first fine location and the second fine location; estimate a phase difference between channel frequency responses of the first bandwidth and the second bandwidth based on the group delay difference; and perform a phase correction of one of the channel frequency responses based on the estimated phase difference.

Example 23 is at least one machine-readable medium including instructions that, when executed by processing circuitry, cause the processing circuitry to perform operations to implement of any of Examples 1-22.

Example 24 is an apparatus comprising means to implement of any of Examples 1-22.

Example 25 is a system to implement of any of Examples 1-22.

Example 26 is a method to implement of any of Examples 1-22.

The above-detailed description includes references to the accompanying drawings, which form a part of the detailed description. The drawings show, by way of illustration, specific aspects in which the invention can be practiced. These aspects are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof) or with respect to other examples (or one or more aspects thereof) shown or described herein.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc., are used merely as labels and are not intended to impose numerical requirements on their objects.

The above description is intended to be illustrative and not restrictive. For example, the above-described examples (or one or more aspects thereof) may be used in combination with each other. Other aspects can be used, such as by one of ordinary skill in the art upon reviewing the above description. The Abstract is provided to allow the reader to quickly ascertain the nature of the technical disclosure. It is submitted with the understanding that it will not be used to interpret or limit the scope or meaning of the claims. Also, in the above Detailed Description, various features may be grouped to streamline the disclosure. This should not be interpreted as intending that an unclaimed disclosed feature is essential to any claim. Rather, inventive subject matter may lie in less than all features of a particular disclosed aspect. Thus, the following claims are hereby incorporated into the Detailed Description, with each claim standing on its own as a separate aspect, and it is contemplated that such aspects can be combined in various combinations or permutations. The scope of the invention should be determined with reference to the appended claims, along with the full scope of equivalents to which such claims are legally entitled.

1-20. (canceled)

21. An apparatus comprising:
one or more antennas; and
transceiver circuitry coupled to the one or more antennas, the transceiver circuitry comprising receiver circuitry and transmitter circuitry, and the transceiver circuitry to:
determine a channel impulse response of a first component carrier associated with a first bandwidth;
determine a location of a first impulse response peak within the first bandwidth;
determine a location of a second impulse response peak within a second bandwidth associated with the first component carrier or with a second component carrier based on the location of the first impulse response peak, the second bandwidth being disjoint with the first bandwidth; and
perform a phase correction of one of a channel frequency response of the first bandwidth and a channel frequency response of the second bandwidth based on the first impulse response peak and the second impulse response peak.

22. The apparatus of claim 21, wherein the transceiver circuitry is further to:
determine a phase difference between the first impulse response peak and the second impulse response peak.

23. The apparatus of claim 22, wherein the transceiver circuitry is further to:
estimate a group delay difference between the first bandwidth and the second bandwidth based on the location of the first impulse response peak, the location of the second impulse response peak, and the phase difference between the first impulse response peak and the second impulse response peak.

24. The apparatus of claim 23, wherein the transceiver circuitry is further to:
estimate a phase difference between a channel frequency response of the first bandwidth and a channel frequency response of the second bandwidth based on the group delay difference.

25. The apparatus of claim 24, wherein the transceiver circuitry is further to:
perform the phase correction of one of the channel frequency response of the first bandwidth and the channel frequency response of the second bandwidth based on the first impulse response peak and the second impulse response peak based on the estimated phase difference between the channel frequency response of the first bandwidth and the channel frequency response of the second bandwidth.

26. The apparatus of claim 21, wherein the transceiver circuitry is further to:
perform an inverse fast Fourier transform (IFFT) of the first bandwidth to determine a dominant peak for an impulse response of the first bandwidth.

27. The apparatus of claim 26, wherein the transceiver circuitry is further to:
perform a search with a fine time grid around the dominant peak to determine the location of the first impulse response peak.

28. The apparatus of claim 27, wherein the transceiver circuitry is further to:
perform a coarse grid search within an area of the first impulse response peak to obtain coarse grid search results associated with the second impulse response peak.

29. The apparatus of claim 28, wherein the transceiver circuitry is further to:
perform a fine grid search within the area of the second impulse response peak to obtain fine grid search results associated with the second impulse response peak;
determine the second impulse response peak based on the fine grid search results;
determine a group delay mismatch between the first bandwidth and the second bandwidth based on a difference between the search for the first impulse response peak and the fine grid search results; and
perform the phase correction based on the group delay mismatch.

30. A method for phase correction, the method comprising:
determining a channel impulse response of a first component carrier associated with a first bandwidth;
determining a location of a first impulse response peak within the first bandwidth;
determining a location of a second impulse response peak within a second bandwidth associated with the first component carrier or with a second component carrier based on the location of the first impulse response peak, the second bandwidth being disjoint with the first bandwidth; and
performing a phase correction of one of a channel frequency response of the first bandwidth and a channel frequency response of the second bandwidth based on the first impulse response peak and the second impulse response peak.

31. The method of claim 30, further comprising:
determining a phase difference between the first impulse response peak and the second impulse response peak.

32. The method of claim 31, further comprising:
estimating a group delay difference between the first bandwidth and the second bandwidth based on the location of the first impulse response peak, the location of the second impulse response peak, and the phase difference between the first impulse response peak and the second impulse response peak;
estimating a phase difference between a channel frequency response of the first bandwidth and a channel frequency response of the second bandwidth based on the group delay difference; and
performing the phase correction of one of the channel frequency response of the first bandwidth and the channel frequency response of the second bandwidth based on the first impulse response peak and the second impulse response peak based on the estimated phase difference between the channel frequency response of the first bandwidth and the channel frequency response of the second bandwidth.

33. A non-transitory computer-readable storage medium that stores instructions for execution by one or more processors of a communication device, the instructions to configure the communication device for signal detection with multiple carrier components with phase mismatch and band gaps between them, and to cause the communication device to:
determine a channel impulse response of a first component carrier associated with a first bandwidth;
determine a location of a first impulse response peak within the first bandwidth;
determine a location of a second impulse response peak within a second bandwidth associated with the first component carrier or with a second component carrier based on the location of the first impulse response peak, the second bandwidth being disjoint with the first bandwidth; and
perform a phase correction of one of a channel frequency response of the first bandwidth and a channel frequency response of the second bandwidth based on the first impulse response peak and the second impulse response peak.

34. The non-transitory computer-readable storage medium of claim 33, wherein the instructions further cause the communication device to:
determine a phase difference between the first impulse response peak and the second impulse response peak.

35. The non-transitory computer-readable storage medium of claim 34, wherein the instructions further cause the communication device to:
estimate a group delay difference between the first bandwidth and the second bandwidth based on the location of the first impulse response peak, the location of the second impulse response peak, and the phase difference between the first impulse response peak and the second impulse response peak.

36. The non-transitory computer-readable storage medium of claim 35, wherein the instructions further cause the communication device to:
estimate a phase difference between a channel frequency response of the first bandwidth and a channel frequency response of the second bandwidth based on the group delay difference.

37. The non-transitory computer-readable storage medium of claim 36, wherein the instructions further cause the communication device to:
perform the phase correction of one of the channel frequency response of the first bandwidth and the channel frequency response of the second bandwidth based on the first impulse response peak and the second impulse response peak based on the estimated phase difference between the channel frequency response of the first bandwidth and the channel frequency response of the second bandwidth.

38. The non-transitory computer-readable storage medium of claim 33, wherein the instructions further cause the communication device to:
perform an inverse fast Fourier transform (IFFT) of the first bandwidth to determine a dominant peak for an impulse response of the first bandwidth.

39. The non-transitory computer-readable storage medium of claim 38, wherein the instructions further cause the communication device to:
perform a search with a fine time grid around the dominant peak to determine the location of the first impulse response peak.

40. The non-transitory computer-readable storage medium of claim 39, wherein the instructions further cause the communication device to:
perform a coarse grid search within an area of the first impulse response peak to obtain coarse grid search results associated with the second impulse response peak;
perform a fine grid search within the area of the second impulse response peak to obtain fine grid search results associated with the second impulse response peak;
determine the second impulse response peak based on the fine grid search results;
determine a group delay mismatch between the first bandwidth and the second bandwidth based on a difference between the search for the first impulse response peak and the fine grid search results; and
perform the phase correction based on the group delay mismatch.
